(19) United States
(12) Patent Application Publication
(10) Pub. No.: US 2026/0011145 A1
(43) Pub. Date: Jan. 8, 2026

(54) INFORMATION PROCESSING APPARATUS, INFORMATION PROCESSING METHOD, AND COMPUTER PROGRAM

(71) Applicant: Shiseido Company, Ltd., Chuo-ku, Tokyo (JP)

(72) Inventors: Naruhito TOYODA, Tokyo (JP); Tomohiro SAKAGUCHI, Tokyo (JP); Hiroki SHIRASAWA, Tokyo (JP); Kan ARAI, Tokyo (JP)

(73) Assignee: Shiseido Company, Ltd., Chuo-ku, Tokyo (JP)

(21) Appl. No.: 18/993,191

(22) PCT Filed: Aug. 4, 2023
(86) PCT No.: PCT/JP2023/028586

§ 371 Date: Jan. 10, 2025

(30) Foreign Application Priority Data
Aug. 10, 2022 (JP) 2022-127740

(51) Int. Cl. G06V 20/20; G06T 11/00; G06V 40/20

(52) U.S. Cl. CPC G06V 20/20; G06T 11/001; G06V 40/28

(57) ABSTRACT

The apparatus includes a module configured to acquire a user video including a beauty motion of a user's hand on each beauty target part, a module configured to identify a motion difference between an exemplary motion and the beauty motion by comparing the exemplary motion with the beauty motion, the motion difference including a position difference which is a motion difference related to a position of the beauty motion and a velocity difference which is a motion difference related to a velocity of the beauty motion; and a module configured to generate navigation information corresponding to the motion difference for each beauty target part.

### TECHNICAL FIELD

The present invention relates to an information processing apparatus, an information processing method, and a program.

### BACKGROUND ART

With the recent digitalization, it has become important to promotion to customers of beauty products (skin care products and makeup products) by value other than the beauty product itself.

Such value is the customer experience.

In particular, it is important for a customer who purchases a beauty product to obtain a customer experience in which the customer performs an appropriate beauty motion (for example, skin care or makeup) by properly using the beauty product.

For this reason, techniques for providing advice on skin care or makeup are known.

For example, Japanese Patent Application Laid-Open 2021-077218 discloses a technology for guiding a user's motion to an exemplary motion.

### SUMMARY OF INVENTION

### Technical Problem

However, Japanese Patent Application Laid-Open 2021-077218 does not take into account beauty motions for the user's face.

As a result, it is not enough promotion to customers interested in beauty.

An object of the present invention is to provide customers interested in beauty with an incentive to continue beauty motion, thereby motivating the customers to make beauty motion a part of their daily routine.

### Solution to Problem

One aspect of the present invention is an apparatus comprising:
a module configured to acquire a user video including a beauty motion of a user's hand on each beauty target part;
a module configured to identify a motion difference between an exemplary motion and the beauty motion by comparing the exemplary motion with the beauty motion, the motion difference including a position difference which is a motion difference related to a position of the beauty motion and a velocity difference which is a motion difference related to a velocity of the beauty motion; and
a module configured to generate navigation information corresponding to the motion difference for each beauty target part.

### BRIEF DESCRIPTION OF DRAWINGS

FIG. 1 is a block diagram showing a configuration of an information processing system of the present embodiment.

FIG. 2 is a functional block diagram of the information processing system of FIG. 1.

FIG. 3 is a diagram illustrating an overview of the present embodiment.

FIG. 4 is a diagram showing the data structure of the user database of the present embodiment.

FIG. 5 is a diagram showing the data structure of the user log database of the present embodiment.

FIG. 6 is a sequence diagram of the information processing of the present embodiment.

FIG. 7 is a diagram showing examples of a screen displayed in the information processing of FIG. 6.

FIG. 8 is a diagram showing examples of a screen displayed in the information processing of FIG. 6.

FIG. 9 is a diagram illustrating an overview of the first modification.

FIG. 10 is a diagram illustrating an overview of the second modification.

FIG. 11 is a diagram illustrating an overview of the third modification.

FIG. 12 is a diagram illustrating an overview of the fourth modification.

FIG. 13 is a sequence diagram of information processing corresponding to the fourth modification.

FIG. 14 is a view showing an example of a screen displayed in the information processing of FIG. 13.

FIG. 15 is a view showing an example of a screen displayed in the information processing of FIG. 13.

FIG. 16 is a diagram showing an example of a screen displayed in the information processing of FIG. 13.

FIG. 17 is a diagram illustrating an overview of the fifth modification.

FIG. 18 is a sequence diagram of information processing of the fifth modification.

FIG. 19 is an explanatory diagram of the scenario of FIG. 17.

FIG. 20 is a view showing an example of a screen displayed in the information processing of FIG. 18.

FIG. 21 is a view showing an example of a screen displayed in the information processing of FIG. 18.

FIG. 22 is a diagram illustrating an overview of the sixth modification.

FIG. 23 is a sequence diagram of information processing of the sixth modification.

FIG. 24 is an explanatory diagram of a facial expression evaluation model (evaluation of the degree of smiling face) of the sixth modification.

FIG. 25 is an explanatory diagram of a facial expression evaluation model (evaluation of the degree of seriousness of face) of the sixth modification.

FIG. 26 is a diagram illustrating an overview of the seventh modification.

### DESCRIPTION OF EMBODIMENTS

Hereinafter, an embodiment of the present invention is described in detail based on the drawings.

Note that, in the drawings for describing the embodiments, the same components are denoted by the same reference sign in principle, and the repetitive description thereof is omitted.

The terms used in the present embodiment are defined as follows.

A “beauty motion” is a motion of the user's hands that is performed on the user's face for care.

The beauty motion includes motion using bare hands and motion using a cosmetic tool (for example, a flat cotton, a triangular sponge, or an applicator).

The beauty motion may be, for example, at least one of the following:
massage motion (for example, pressing acupressure points);
skin care motion;
makeup motion; and
sun care motion (for example, application of a sun care agent).

The “user video” is a video of beauty motion performed with the hands on each part of the face.

“User position” is the relative position of the hand with respect to each part of the face in each frame of the user video.

“User velocity” is the amount of displacement of the user's position between frames of the user video.

### (1) Configuration of Information Processing System

The configuration of information processing system will be described.

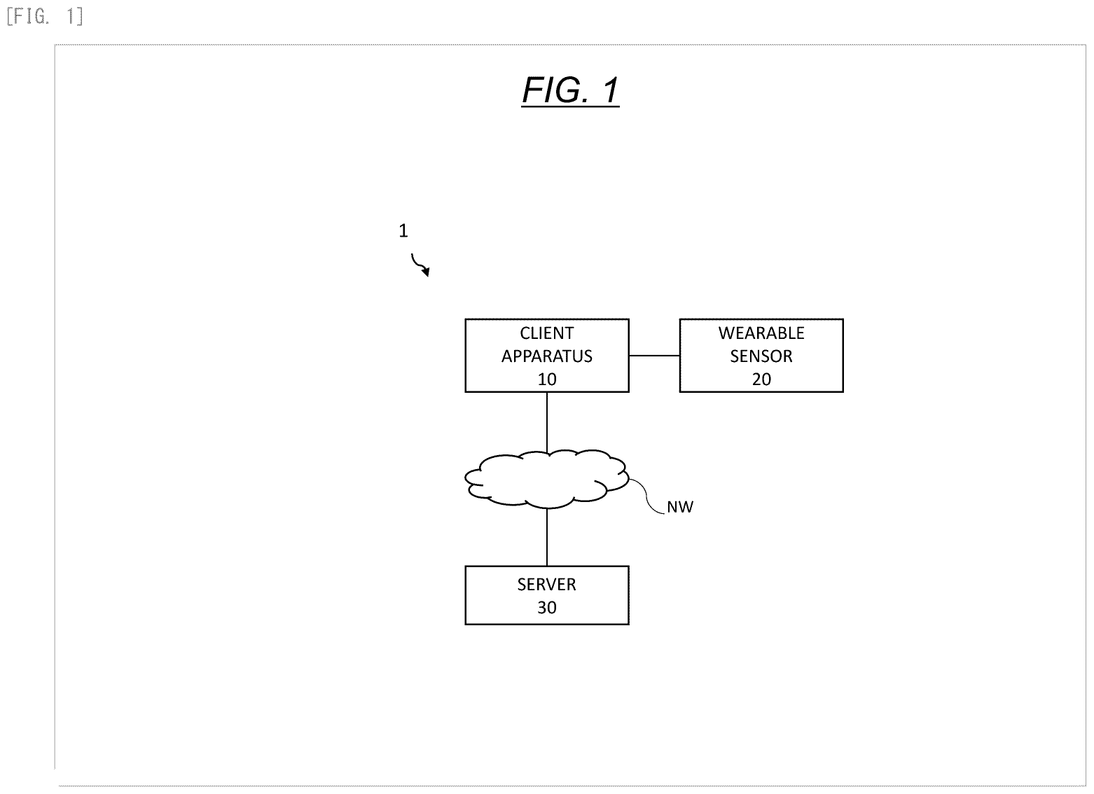

FIG. 1 is a block diagram showing the configuration of an information processing system of the present embodiment.

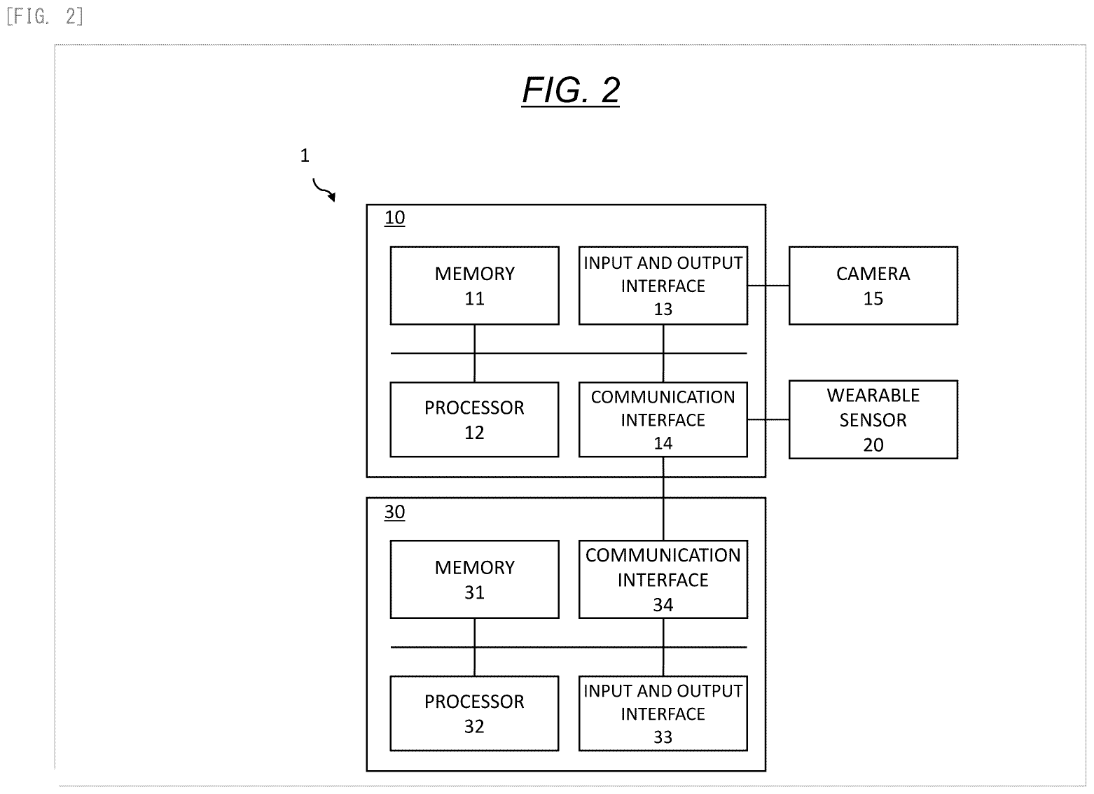

FIG. 2 is a functional block diagram of the information processing system of FIG. 1.

As shown in FIG. 1, the information processing system 1 includes a client apparatus 10, a wearable sensor 20, and a server 30.

The client apparatus 10 and server 30 are connected via a network (for example, an internet or an intranet) NW.

The wearable sensor 20 is communicatively connected to the client apparatus 10.

The client apparatus 10 is a computer (an example of an “information processing apparatus”) that transmits a request to the server 30.

The client apparatus 10 is, for example, a smart mirror, a smartphone, a tablet device, or a personal computer.

The wearable sensor 20 can be worn by a user.

The wearable sensor measures, for example, at least one of the following values and transmits the measurement result to the client apparatus 10:
biometric information (for example, body temperature, heart rate, and blood flow);
acceleration information (for example, information about the acceleration of a hand);
pressure information (for example, information about the pressure applied by a hand to a face);
information about the direction of rotation of the three axes of the hand; and
information about myoelectricity.

The server 30 is a computer (an example of an “information processing apparatus”) that provides the client apparatus 10 with a response in response to a request sent from the client apparatus 10.

The server 30 is, for example, a web server.

### (1-1) Configuration of Client Apparatus

A configuration of the client apparatus 10 will be described.

As shown in FIG. 2, the client apparatus 10 includes a memory 11, a processor 12, an input and output interface 13, and a communication interface 14, and a camera 15.

The memory 11 is configured to store programs and data.

The memory 11 is, for example, a combination of a ROM (read only memory), a RAM (random access memory), and a storage (for example, a flash memory or a hard disk).

The programs include, for example, the following programs:
OS (Operating System) program; and
programs of applications that execute information processing (for example, web browsers).

The data includes, for example, the following data:
databases referenced in information processing; and
data obtained by executing information processing (that is, the results of information processing).

The processor 12 is configured to implement the functions of the client apparatus 10 by activating programs stored in the memory 11.

The processor 12 is, for example, a CPU (Central Processing Unit), an ASIC (Application Specific Integrated Circuit), an FPGA (Field Programmable Gate Array), or a combination thereof.

The input and output interface 13 is configured to acquire a user's instruction from input devices connected to the client apparatus 10 and output information to output devices connected to the client apparatus 10.

The input device is, for example, a keyboard, a pointing device, a touch panel, or a combination thereof.

The output device is, for example, a display, a speaker, or a combination thereof.

The communication interface 14 is configured to control communications between the client apparatus 10 and the server 30.

The camera 15 is configured to capture the user video including beauty motion of the user's hands on each part of the user's face.

The camera 15 includes, for example, at least one of the following:
image sensor; and
thermal camera.

### (1-2) Configuration of Server

A configuration of the server 30 will be described.

As shown in FIG. 2, the server 30 includes a memory 31, a processor 32, an input and output interface 33, and a communication interface 34.

The memory 31 is configured to store a program and data.

The memory 31 is, for example, a combination of ROM, RAM, and storage (for example, flash memory or hard disk).

The programs include, for example, the following programs:
OS program; and
programs of applications that execute information processing.

The data includes, for example, the following data:
databases referenced in information processing; and
data obtained by executing information processing.

The processor 32 is configured to implement the functions of the server 30 by activating programs stored in the memory 31.

The processor 32 is, for example, a CPU, ASIC, FPGA, or a combination thereof.

The input and output interface 33 is configured to acquire user's instruction from input devices connected to the server 30 and to output information to output devices connected to the server 30.

The input device is, for example, a keyboard, a pointing device, a touch panel, or a combination thereof.

The output device is, for example, a display.

The communication interface 34 is configured to control communications between the server 30 and the client apparatus 10.

### (2) Summary of Embodiment

A summary of the present embodiment will be described.

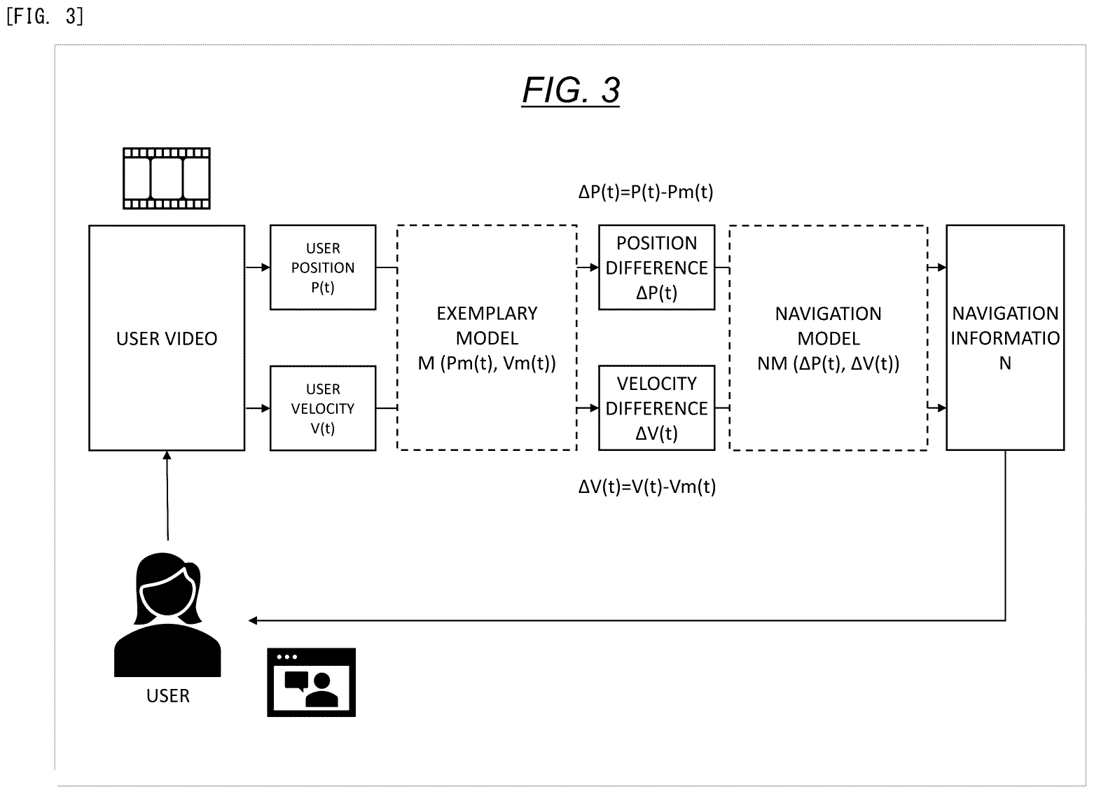

FIG. 3 is a diagram illustrating an overview of the present embodiment.

As shown in FIG. 3, by analyzing the user video including the user's beauty motion, a user's position P(t) and a user's velocity V(t) in each frame F(t) of the user video are identified.

“t” is an example of information for identifying a frame.

By inputting the user position P(t) and the user velocity V(t) into the exemplary model M(Pm(t), Vm(t)), a motion difference ΔP(t) between the user position P(t) and the exemplary position Pm(t) (hereinafter referred to as the “position difference”), and a velocity difference ΔV(t) between the user velocity V(t) and the exemplary velocity Vm(t) (hereinafter referred to as the “velocity difference”) are obtained.

Navigation information is obtained by inputting the position difference ΔP(t) and the velocity difference ΔV(t) into the navigation model NM(ΔP(t), ΔV(t)).

The navigation information is presented to a user.

For example, in the case that the beauty motion is a massage motion, the navigation information for the motion of massaging the cheeks (for example, the motion of pressing acupressure points on one's cheeks with one's fingers, or the motion of pressing acupressure points on one's cheeks using an acupressure tool) is generated.

For example, in the case that the beauty motion is a skin care motion, the navigation information for the motion of applying lotion, serum, cream, or milky lotion is generated.

For example, in the case that the beauty motion is a makeup motion, the navigation information for a motion of using foundation, base, blush, eyebrow, eyeshadow, mascara, or lipstick is generated.

For example, in the case that the beauty motion is a sun care motion, the navigation information for the motion of applying a UV (Ultraviolet) agent (for example, a liquid, powder, or spray agent) is generated.

### (3) Database

A database of the present embodiment will be described.

The following databases are stored in the memory 31.

### (3-1) User Database

The user database of the present embodiment will be described.

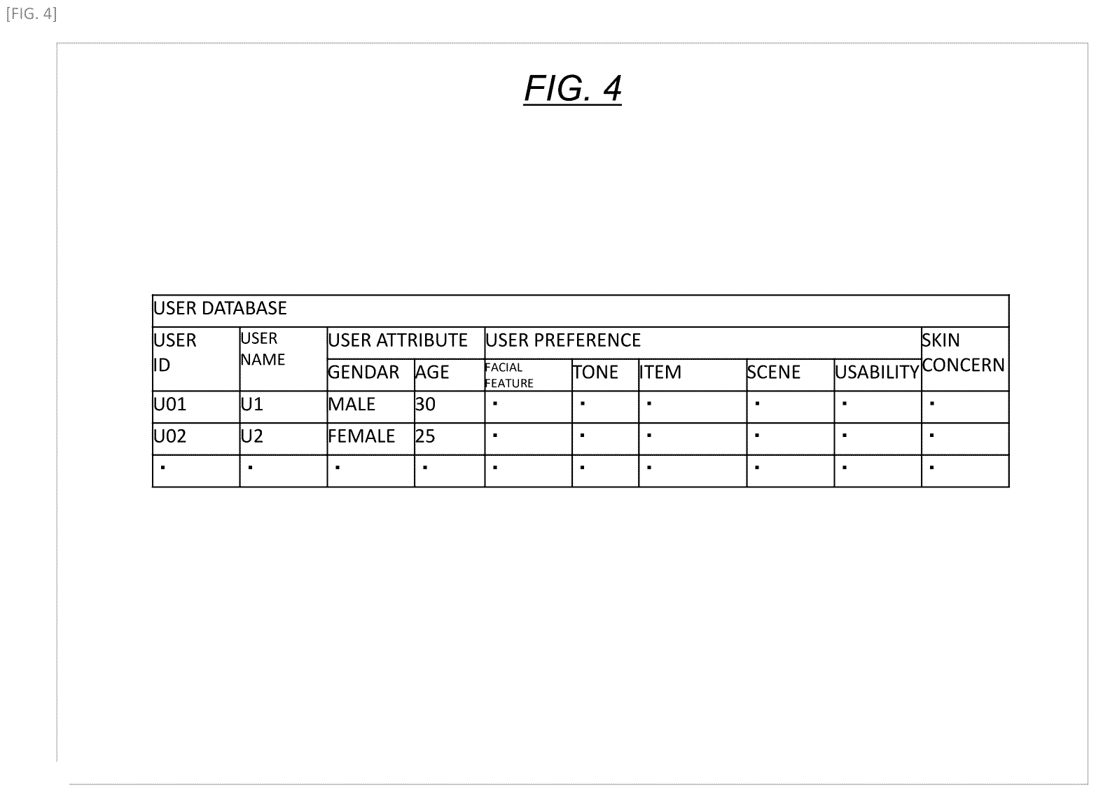

FIG. 4 is a diagram showing the data structure of the user database of the present embodiment.

The user database in FIG. 4 stores user information.

The user database includes a “user ID” field, and a “user name” field, a “user attribute” field, a “user preference” field, and a “skin concern” field.

Each field is associated with each other.

The “user ID” field stores user identification information.

The user identification information is information for identifying a user.

The “user name” field stores user name information.

The user name information is information about the user's name.

The “user attribute” field stores user attribute information.

The user attribute information is information relating to the attributes of a user.

The “user attribute” field includes a “gender” field, and a “age” field.

The “gender” field stores gender information.

The gender information is information about the gender of the user.

The “age” field stores age information.

The age information is information about the age of the user.

The “user preference” field stores user preference information.

The user preference information is information regarding the preferences of the user.

The “user preference” field includes a “facial feature” field, a “tone” field, an “item” field, a “scene” field, and a “usability” field.

The “facial feature” field stores facial feature information.

The facial feature information is information about the facial features preferred by the user.

The “tone” field stores tone information.

The tone information is information related to the color tone preferred by the user.

The “item” field stores item information.

The item information is information about items that the user likes.

The “scene” field stores scene information.

The scene information is information related to a scene that the user likes.

The “skin concern” field stores skin concern information.

The skin concern information is information about the user's skin trouble.

The skin concerns include, for example, at least one of the following:
rough skin;
drying;
stains;
sagging;
acupuncture; and
dullness.

The “usability” field stores usability information.

The usability information is information about the usability of an item.

The usability of an item may be, for example, at least one of the following:
feeling recognized by touch (for example, moist or refreshing); and
feelings felt during or after application (for example, how easy it spreads, how well it blends in, or how moist it is).

### (3-2) User Log Database

The user log database of the present embodiment will be described.

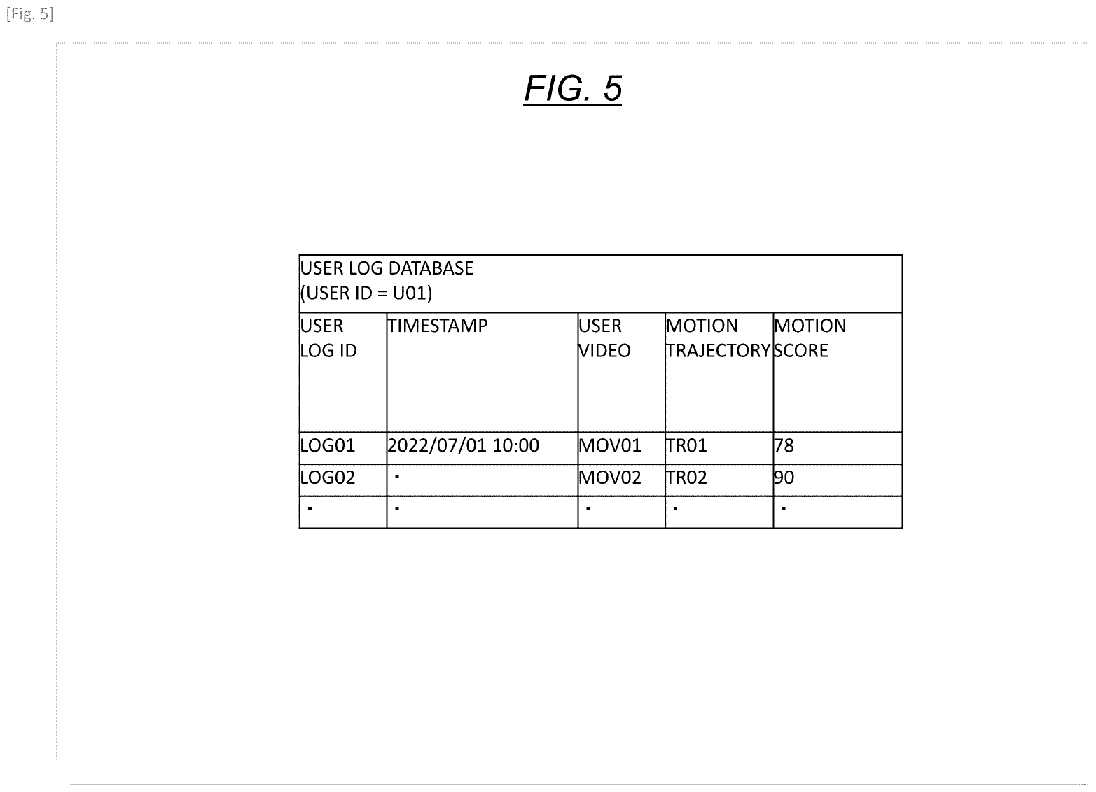

FIG. 5 is a diagram showing the data structure of the user log database of the present embodiment.

The user log database in FIG. 5 stores user log information.

The user database includes a “user log ID” field, a “timestamp” field, a “user video” field, a “motion trajectory” field, and a “motion score” field.

Each field is associated with each other.

The user log database is associated with the user identification information.

The “user log ID” field stores user log identification information.

The user log identification information is information for identifying a user log.

The “timestamp” field stores timestamp information.

The timestamp information is information relating to the date and time corresponding to the user log.

The “user video” field stores user video captured by the camera 15.

The “motion trajectory” field stores motion trajectory information.

The motion trajectory information is information regarding the trajectory of a beauty motion.

The “motion score” field stores the motion score.

The motion score is the score of the beauty motion performed by the user.

### (4) Information Processing

The information processing of the present embodiment will be described.

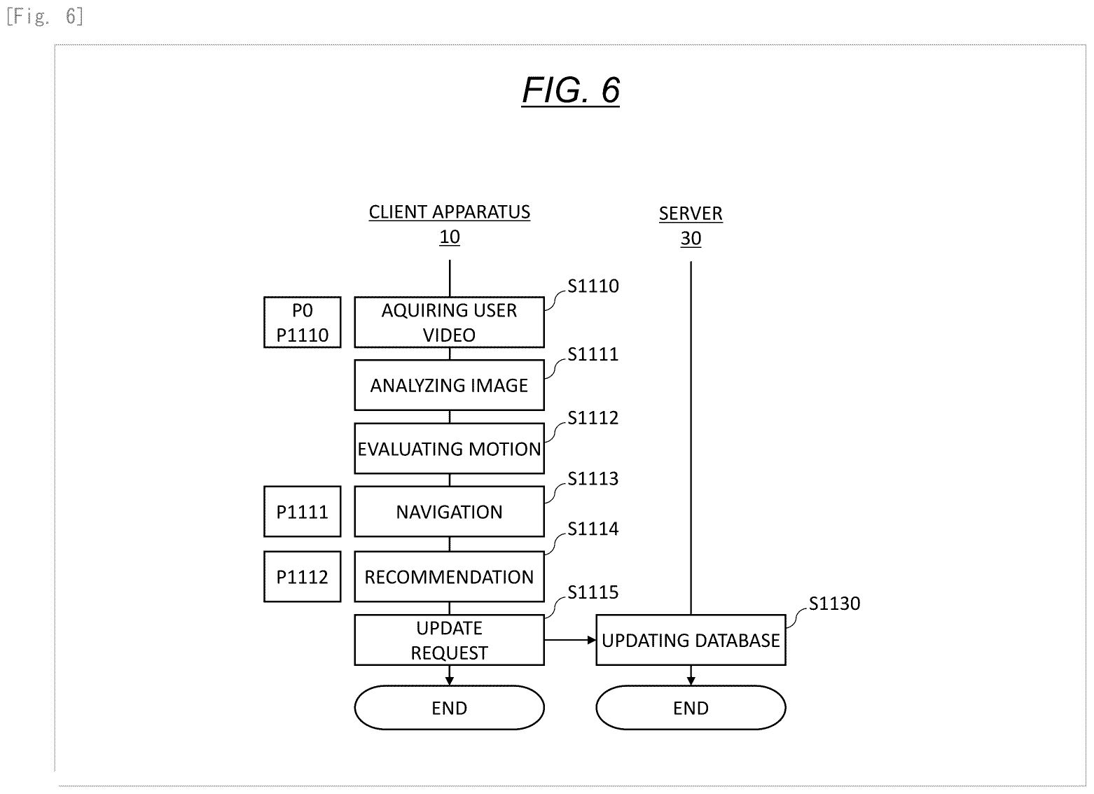

FIG. 6 is a sequence diagram of the information processing of the present embodiment.

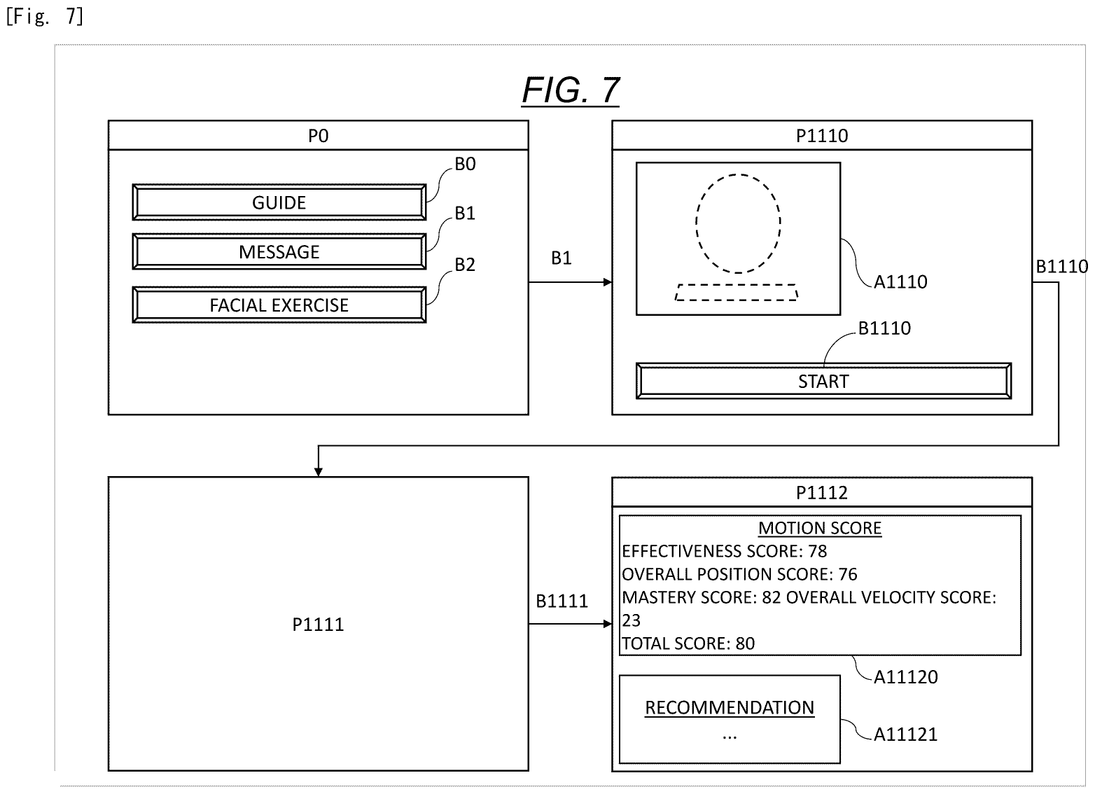

FIG. 7 is a diagram showing examples of a screen displayed in the information processing of FIG. 6.

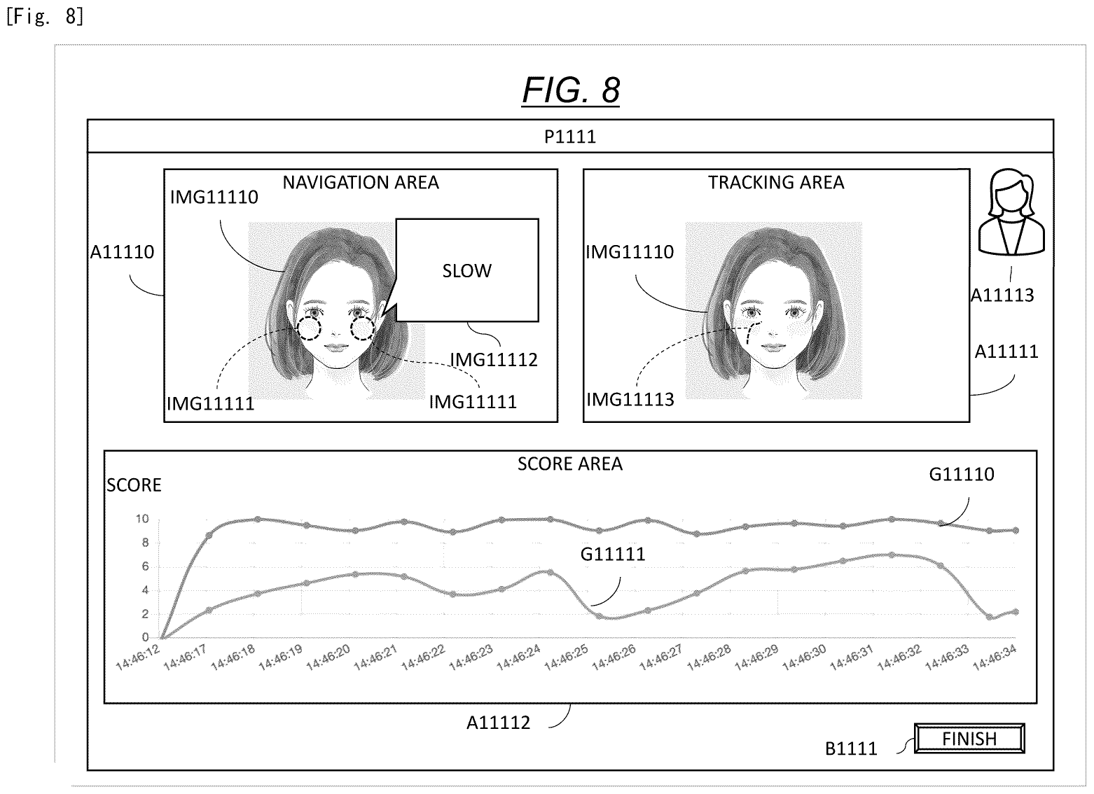

FIG. 8 is a diagram showing examples of a screen displayed in the information processing of FIG. 6.

The information processing of FIG. 6 is started when the user of the client apparatus 10 gives a user instruction to activate a navigation application installed on the client apparatus 10.

The user identification information of the user is registered in the navigation application.

As shown in FIG. 6, the client apparatus 10 executes acquiring user video (S1110).

Specifically, the processor 12 displays a screen P0 (FIG. 7) on the display.

The screen P0 includes operation objects B0 to B2.

The operation object B0 is an object that receives a user instruction for displaying guide information.

The guide information is information that provides guidance on how to use the navigation application.

The guide information is, for example, at least one of the following:
still images;
video;
audio; and
text.

When the user operates the operation object B0, the processor 12 displays guide information pre-stored in the memory 11 on the display.

The operation object B1 is an object that receives a user instruction to start the massage mode.

The massage mode is a mode that provides navigation for beauty motion performed using hands on a beauty target part for beauty motion.

The operation object B2 is an object that receives a user instruction to start the facial exercise mode.

The facial exercise mode provides hands-free navigation of beauty motion on facial areas.

When the user operates the operation object B1, the processor 12 displays a screen P1110 (FIG. 7) on the display.

The screen P1110 includes a display object A1110 and an operation object B1110.

A guide is displayed on the display object A1110.

The operation object B1110 is an object that receives a user instruction to start navigation.

When the user aligns the position of his/her face with the guide of the display object A1110 and operates the operation object B1110, the camera 15 starts capturing the user video.

The processor 12 acquires the user video captured by the camera 15.

When the user performs a beauty motion after operating the operation object B1110, the user video includes an image of the beauty motion.

After step S1110, the client apparatus 10 executes analyzing image (S1111).

Specifically, the processor 12 analyzes the user video to recognize, for each frame constituting the user video, feature points of the area of the user that is the target of the beauty motion (hereinafter referred to as the “beauty target part”) and feature points of the user's hand (for example, the fingertips).

The beauty target part includes, for example, at least one of the following:
head;
each part of face (for example, eyebrow, eye, nose, mouth, and cheek);
neck;
jaw;
ear; and
shoulder.

For each frame, the processor 12 identifies an area of the user's face (hereinafter referred to as the “target area”) based on the coordinates of each beauty target part of the user.

The processor 12 identifies the position of the user's hand that is included in the target area in the frame F(t) as the user position P(t).

The processor 12 calculates the user velocity V(t) based on the amount of displacement (P(t+1)-P(t)) of the user position between frames F(t) and F(t+1).

After step S1111, the client apparatus 10 executes evaluating motion (S1112).

Specifically, the memory 11 stores an exemplary model M.

In the exemplary model M, an exemplary motion is described.

The exemplary motion is defined by an exemplary position Pm(t) and an exemplary velocity Vm(t).

When the exemplary position Pm(t1) in frame t1 and the exemplary position P(t2) in frame t2 indicate the same position, this means that the position of the beauty motion is stationary from frame t1 to t2.

The processor 12 refers to the exemplary model M to calculate the position difference ΔP(t) which is the difference between the user position P(t) and the exemplary position Pm(t).

The processor 12 refers to the exemplary model M to calculate a velocity difference ΔV(t) which is the difference between the user velocity V(t) and the exemplary velocity Vm(t).

The memory 11 stores a time-series score model.

The time-series score model describes the correlation between the evaluation results of motion (for example, position difference ΔP(t) and velocity difference ΔV(t)) and the motion score at a point in time (hereinafter referred to as the “time-series motion score”).

When the processor 12 inputs the position difference ΔP(t) to the time-series score model, the score model outputs a time-series position score according to the position difference ΔP(t).

When the processor 12 inputs the velocity difference ΔV(t) to the time-series score model, the score model outputs a time-series velocity score according to the velocity difference ΔV(t).

After step S1112, the client apparatus 10 executes generating navigation information (S1113).

A first example of step S1113 will be described.

The first example of step S1113 is an example in which an image is used as navigation information.

The memory 11 stores a navigation model NM.

The navigation model NM describes the correlation between the combination of the position difference ΔP(t) and the velocity difference ΔV(t) and the navigation information.

The processor 12 inputs the position difference ΔP(t) and the velocity difference ΔV(t) which are obtained in step S1112 into the navigation model NM to generate navigation information corresponding to the combination of the position difference ΔP(t) and the velocity difference ΔV(t).

The processor 12 displays a screen P1111 (FIG. 8) on the display while the beauty motion is performed.

The screen P1111 includes display objects A11110 to A11113 and an operation object B1111.

The display object A11110 is a navigation area.

The display object A11110 displays a user video IMG11110, and images indicating navigation information (hereinafter referred to as “navigation images”) IMG11111 to IMG11112.

The navigation images IMG11111-IMG1112 are displayed superimposed on the user video (that is, an image of the user's face) IMG1110.

The navigation image may include, for example, at least one of the following:
image showing the position on the beauty target part to which the beauty motion should be applied; and
animation image that guides the movement of the beauty motion (for example, an animation of an arrow image showing the direction and speed of hand movement).

The processor 12 may adjust the velocity of the movement of the arrow according to the velocity difference ΔV(t) in the case that the navigation image is an animated image.

For example, if the velocity difference ΔV(t) is a positive value (that is, the beauty motion is faster than the exemplary motion), the processor 12 plays the animated image changes at a slower velocity than the standard velocity.

For example, if the velocity difference ΔV(t) is a negative value (that is, the beauty motion is slower than the exemplary motion), the processor 12 plays the animated image changes at a faster than standard speed.

The navigation image IMG11111 includes, for example, at least one of the following formats:
message image showing an evaluation of a beauty motion and advice on a beauty motion (for example, a speech bubble image)
position guidance image that guides the position of a beauty motion (for example, a dot image that moves in an appropriate direction);
speed guidance image that guides the speed of a beauty motion (for example, a dot image that blinks at an appropriate speed); and
computer graphics image of a hand that changes depending on the position of the beauty motion (for example, a hand that changes in an appropriate direction and/or at an appropriate speed).

The navigation image IMG11112 shows a navigation message.

The context of the navigation message includes at least one of the following:
evaluation of beauty motion (for example, “GOOD” or “BAD”); and
advice on beauty motion (for example, the next beauty motion to be performed or the beauty motion to be improved (for example, “go more slowly”)).

The display object A1111 is a tracking area.

The display object A1111 displays image objects IMG11110 and IMG11113.

The image object IMG11113 is a path image.

The trajectory image is an image showing the trajectory of a beauty motion (for example, the trajectory of a user's hand) during a predetermined period (for example, the period from three seconds before the execution of step S1113 to the execution of step S1113).

The display object A11112 is a score area.

The display object A11110 displays graphs G11110 to G11111 which indicate the motion scores in chronological order of beauty motion.

The graph G11110 is a graph of time series position scores.

The graph G11111 is a graph of time series velocity scores.

By displaying the motion scores along a time series, the user can easily know the quality (that is, accuracy) of the evaluation of the motion indicators (velocity and position) for each step.

This allows the user to objectively grasp his/her own skills.

The display object A11113 is an object that displays a model image.

The model image changes in accordance with the time sequence of the beauty motions.

The model image is, for example, at least one of the following:
still image showing a model at time T1 synchronized with frame t1 of the model behavior;
video showing a model at time T1 synchronized with frame t1 of the exemplary motion;
still image showing a model at time T2, which is before frame t1 of the exemplary motion; and
video showing a model at time T2, which is before frame t1 of the exemplary motion.

The model image can encourage the user to perform beauty motions in accordance with the exemplary motions.

The operation object B1111 is an object that receives a user instruction for requesting a recommendation according to the beauty motion.

A second example of step S1113 will be described.

The second example of step S1113 is an example in which audio is used as navigation information.

The memory 11 stores the navigation model NM, as in the first example of step S1113.

The processor 12 generates a navigation message in the same manner as the first example of step S1113.

The processor 12 outputs voice information corresponding to the navigation message (hereinafter referred to as “navigation voice information”) from the speaker.

Navigation voice information is an example of “sound information.”

The context of the navigation voice information is similar to the navigation image of the first example of step S1113.

The navigation voice information includes, for example, at least one of the following:
BGM (Background Music);
voice of applied texts (explanatory text as an example); and
voice that reads feedback ratings during navigation.

The memory 11 stores a navigation model NM.

The navigation model NM describes the correlation between the combination of the position difference ΔP(t) and the velocity difference ΔV(t) and the sound conversion parameters.

The processor 12 generates sound conversion parameters corresponding to the combination of the position difference ΔP(t) and the velocity difference ΔV(t) obtained in step S1112 by inputting the position difference ΔP(t) and the velocity difference ΔV(t) into the navigation model NM.

The memory 11 stores predetermined sound information (for example, information to be reproduced while a beauty motion is performed).

The processor 12 generates converted sound information by converting the sound information using the sound conversion parameters.

The processor 12 outputs the converted sound information from a speaker.

A third example of step S1113 will be described.

The third example of step S1113 is an example in which the display form of the screen is used as navigation information.

The memory 11 stores the navigation model NM, as in the first example of step S1113.

The processor 12 generates a navigation message in the same manner as the first example of step S1113.

When at least one of the time-series position score and the time-series motion score is less than a predetermined threshold, the processor 12 displays the screen P1111 in a warning form (for example, in yellow or flashing).

When both the time-series position score and the time-series motion score are equal to or greater than the threshold, the processor 12 displays the screen P1111 in a display form different from the warning form (for example, blue or lit).

The first to third examples of step S1113 may be combined with each other.

After step S1113, the client apparatus 10 executes recommendation (S1114).

Specifically, the memory 11 stores an overall motion score model.

The overall motion score model describes the correlation between the combination of the overall position difference ΔP(t) and velocity difference ΔV(t) of the user video and the overall motion score.

The overall motion score includes, for example, at least one of the following:
effect score indicating the overall effect of beauty motion;
proficiency score indicating the proficiency level of the overall beauty motion;
comprehensive score indicating the overall evaluation of the entire beauty motion;
overall position score indicating the evaluation of the position of the entire beauty motion; and
overall velocity score indicating the overall velocity evaluation of beauty motion.

The memory 11 stores a recommendation model.

In the recommendation model, a correlation between a combination of the overall position difference ΔP(t) and velocity difference ΔV(t) of the user video and recommendation information is described.

The recommendation information includes, for example, at least one of the following:
products recommended for the user's care (for example, care tools, care products (specifically, massage essence or cream), makeup tools (specifically, cotton of different hardness, sponges, puffs, or brushes), or advice on cosmetics);
advice on more effective beauty methods; and
advice for improving beauty motion.

When the user operates the operation object B11120, the processor 12 inputs the combination of the position difference ΔP(t) and velocity difference ΔV(t) of the entire user video obtained in step S1112 into the overall motion score model, and determines an overall motion score corresponding to the combination of the position difference ΔP(t) and velocity difference ΔV(t).

The processor 12 inputs the combination of the position difference ΔP(t) and velocity difference ΔV(t) of the entire user video obtained in step S1112 into the recommendation model, thereby generating recommendation information corresponding to the combination of the position difference ΔP(t) and velocity difference ΔV(t).

The processor 12 displays a screen P1112 (FIG. 7) on the display.

The screen P1112 includes display objects A11120 to A11121.

The display object A11120 displays motion scores (for example, effectiveness score, mastery score, total score, overall position score, and overall velocity score).

The display object A11121 displays recommendation information (for example, text information and image information).

After step S1114, the client apparatus 10 executes an update request (S1115).

Specifically, the processor 12 transmits update request data to the server 30.

The update request data includes, for example, the following information:
user identification information;
information regarding the execution date and time of step S1114 (hereinafter referred to as “timestamp information”);
user video obtained in step S1110;
information indicating the user position P(t) in the entire user video obtained in step S1111; and
the motion score obtained in step S1113.

After step S1115, the server 30 updates the database (S1130).

Specifically, the processor 32 adds a new record to the user log database (FIG. 5) associated with the user identification information included in the update request data.

The following information is stored in each field of the new record:
“user log ID” field: new user log identification information;
“timestamp” field: timestamp information included in the update request data;
“user video” field: user video included in the update request data;
“motion trajectory” field: information indicating the user position P(t) included in the update request data; and
“motion score” field: motion score included in the update request data.

### (5) Summary of the Present Embodiment

According to the present embodiment, the navigation information corresponding to a combination of the position and velocity for each beauty target part of the user is presented to the user.

This allows the user to perform beauty motion while taking into account the navigation information.

As a result, it is possible to provide users who are interested in beauty and who are potential customers with an incentive to continue beauty activities.

According to the present embodiment, the navigation image IMG11111 may be generated as navigation information, and the navigation image IMG11111 may be displayed superimposed on the user video IMG11110.

This allows the user to perform beauty motions while simultaneously viewing his or her own face and the navigation image IMG11111.

According to the present embodiment, the position guidance image that guides the position of a beauty motion and the velocity guidance image that guides the velocity of the beauty motion are generated as navigation information, and the position guidance image and the velocity guidance image may be superimposed on the user video IMG11110.

This allows the user to perform beauty motion following individual guidance regarding the position and velocity of the beauty motion while simultaneously viewing his or her own face and the navigation image IMG11111.

According to the present embodiment, an image of a hand that changes depending on the position of a beauty motion may be generated as navigation information.

This allows the user to perform beauty motion while visually checking the navigation image showing the user performing the beauty motion on his or her own face with his or her hands.

### (6) Modification

A modification of the present embodiment will be described.

### (6-1) First Modification

The first modification will be described.

The first modification is an example in which evaluating motion (S1112) takes into consideration the user pressure in addition to the user position and user velocity.

### (6-1-1) Overview of First Modification

The overview of the first modification will be described.

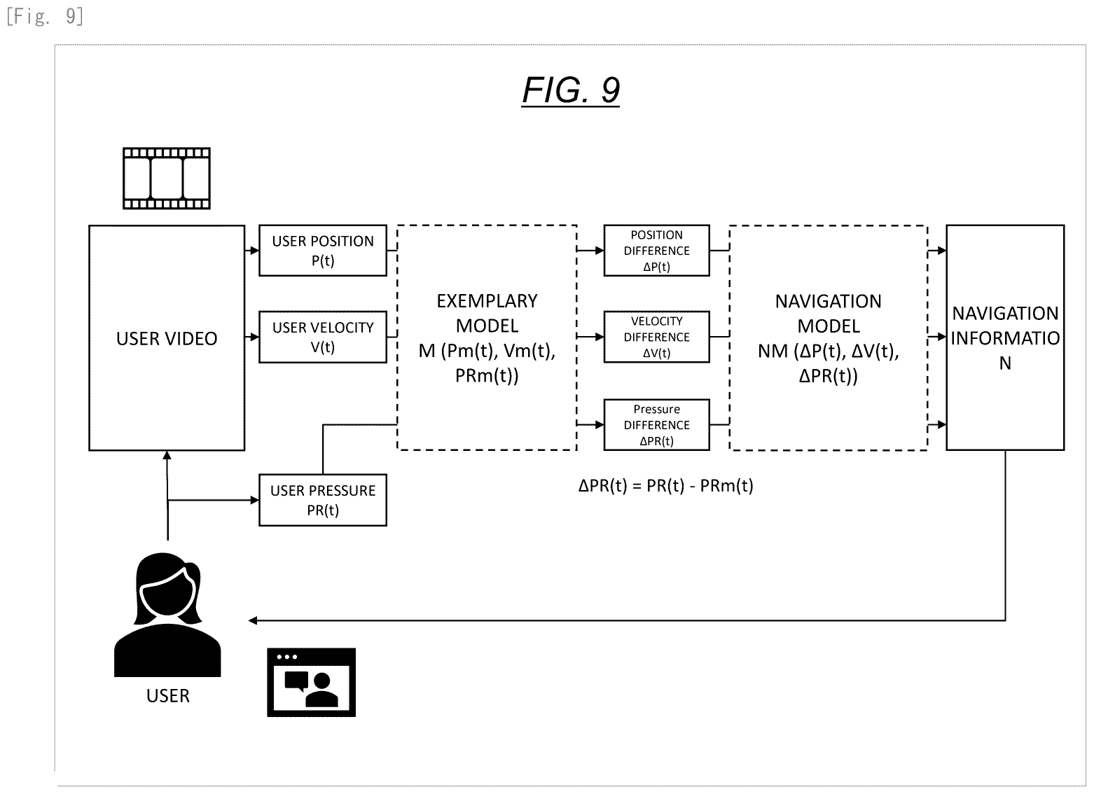

FIG. 9 is a diagram illustrating an overview of the first modification.

As shown in FIG. 9, by analyzing the user video the user position P(t) and the user velocity V(t) in each frame F(t) of the user video are identified.

A user pressure PR(t) applied to the user's face by the user's hand is determined from the wearable sensor 20 worn by the user.

By inputting the user position P(t), user velocity V(t), and user pressure PR(t) into the exemplary model M (Pm(t), Vm(t), PRm(t)), the position difference ΔP(t), the velocity difference ΔV(t), and the pressure difference ΔPR(t) between the user pressure PR(t) and the exemplary pressure PRm(t) are obtained.

Navigation information is obtained by inputting the position difference ΔP(t), the velocity difference ΔV(t), and the pressure difference ΔPR(t) into the navigation model NM(ΔP(t), ΔV(t), ΔPR(t)).

The navigation information is presented to a user.

### (6-1-2) Information Processing of First Modification

The information processing of the first modification will be described.

The trigger for starting the process of the first modification is the same as that shown in FIG. 6.

The client apparatus 10 executes acquiring user video (S1110) in the same manner as in FIG. 6.

After step S1110, the client apparatus 10 executes analyzing image (S1111).

Specifically, the processor 12 analyzes the user video to recognize, for each frame F(t) constituting the user video, the user's beauty target part and the user's hand (for example, fingertips).

The processor 12 identifies a target area for each frame F(t) based on the coordinates of each beauty target part of the user.

The processor 12 identifies the coordinates of the user's hand in the frame F(t) that are included in the target area as the user position P(t).

The processor 12 calculates the user velocity V(t) based on the amount of displacement (P(t+1)-P(t)) of the user position between frames F(t) and F(t+1).

The processor 12 determines the user pressure PR(t) applied by the user's hand to the user's face based on changes in the user's hand (for example, changes in skin wrinkles) at the user position P(t) in frame F(t).

After step S1111, the client apparatus 10 executes evaluating motion (S1112).

Specifically, the memory 11 stores an exemplary model M.

In the exemplary model M, an exemplary motion is described.

The exemplary motion is defined by an exemplary position Pm(t), an exemplary velocity Vm(t), and an exemplary pressure PRm(t).

The processor 12 refers to the exemplary model M to calculate the position difference ΔP(t) which is the difference between the user position P(t) and the exemplary position Pm(t).

The processor 12 refers to the exemplary model M to calculate a velocity difference ΔV(t) which is the difference between the user velocity V(t) and the exemplary velocity Vm(t).

The processor 12 refers to the exemplary model M to calculate the pressure difference ΔPR(t) which is the difference between the user pressure PR(t) and the exemplary pressure PRm(t).

The memory 11 stores a time-series score model.

The time-series score model describes the correlation between the motion evaluation results (for example, the position difference ΔP(t), the velocity difference ΔV(t), and the pressure difference ΔPR(t)) and the time-series motion score.

When the processor 12 inputs the position difference ΔP(t) to the time-series score model, the score model outputs a time-series position score corresponding to the position difference ΔP(t).

When the processor 12 inputs the velocity difference ΔV(t) to the time-series score model, the score model outputs a time-series velocity score corresponding to the velocity difference ΔV(t).

When the processor 12 inputs the pressure difference ΔPR(t) to the time-series score model, the score model outputs a time-series pressure score corresponding to the pressure difference ΔPR(t).

After step S1112, the client apparatus 10 executes navigation (S1113).

A first example of step S1113 in the first modification will be described.

The first example of step S1113 in the first modification is an example in which an image is used as navigation information.

The memory 11 stores a navigation model NM.

The navigation model NM describes the correlation between the combination of the position difference ΔP(t), the velocity difference ΔV(t), and the pressure difference ΔPR(t) and the navigation information.

The processor 12 inputs the position difference ΔP(t), velocity difference ΔV(t), and pressure difference ΔPR(t) obtained in step S1112 into the navigation model NM, thereby generating navigation information corresponding to the combination of the position difference ΔP(t), velocity difference ΔV(t), and pressure difference ΔPR(t).

The processor 12 displays a screen P1111 (FIG. 8) on the display while the beauty motion is performed.

The second example of step S1113 in the first modification is similar to the second example of step S1113 in FIG. 6.

The first and second examples of step S1113 in the first modification may be combined.

The memory 11 stores a navigation model NM.

The navigation model NM describes the correlation between the combination of the position difference ΔP(t), the velocity difference ΔV(t), and the pressure difference ΔPR(t) and the sound conversion parameters.

The processor 12 inputs the position difference ΔP(t), velocity difference ΔV(t), and pressure difference ΔPR(t) obtained in step S1112 into the navigation model NM, thereby generating sound conversion parameters corresponding to the combination of the position difference ΔP(t), velocity difference ΔV(t), and pressure difference ΔPR(t).

The memory 11 stores predetermined sound information (for example, information to be reproduced while a beauty motion is performed).

The processor 12 generates converted sound information by converting the sound information using the sound conversion parameters.

The processor 12 outputs the converted sound information from a speaker.

After step S1113, the client apparatus 10 executes recommendation (S1114).

Specifically, the memory 11 stores an overall motion score model.

The overall motion score model describes the correlation between the overall motion score and a combination of the overall position difference ΔP(t), velocity difference ΔV(t), and pressure difference ΔPR(t) of the user video.

The memory 11 stores a recommendation model.

In the recommendation model, the correlation between the combination of the overall position difference ΔP(t), the velocity difference ΔV(t), and the pressure difference ΔPR(t) of the user video and the recommendation information is described.

When the user operates the operation object B11120, the processor 12 inputs the combination of the position difference ΔP(t), velocity difference ΔV(t), and pressure difference ΔPR(t) of the entire user video obtained in step S1112 into the overall motion score model, and determines an overall motion score corresponding to the combination of the position difference ΔP(t), velocity difference ΔV(t), and pressure difference ΔPR(t).

The processor 12 inputs the combination of the position difference ΔP(t), velocity difference ΔV(t), and pressure difference ΔPR(t) of the overall user video obtained in step S1112 into the recommendation model, and generates recommendation information corresponding to the combination of the position difference ΔP(t), velocity difference ΔV(t), and pressure difference ΔPR(t).

The processor 12 displays a screen P1112 (FIG. 7) on the display.

After step S1114, the client apparatus 10 executes update request (S1115) in the same manner as in FIG. 6.

After step S1115, the server 30 executes updating database (S1130) in the same manner as in FIG. 6.

### (6-1-3) Summary of Modification 1

According to the first modification, the navigation information corresponding to a combination of the position, velocity, and pressure for each beauty target part of the user is presented to the user.

This allows the user to perform beauty motion while taking into account the navigation information.

As a result, users who become customers interested in beauty can be given a greater incentive to continue beauty activities.

In particular, the first modification is particularly suitable when it is preferable to vary the pressure depending on the beauty target part, or when it is preferable to gradually vary the pressure locally and sequentially even on the same beauty target part (for example, when the beauty motion is a massage or applying operation).

More specifically, when the beauty motion is a massage of acupressure points, the user is guided to press the acupressure points with a pressure appropriate to the beauty target part.

This maximizes the massage effect.

When the beauty motion is applying foundation, the applying motion is guided with a pressure corresponding to the type of foundation or the desired finish.

This ensures that the foundation powder is properly applied to the skin.

In the first modification, instead of identifying the user pressure PR(t) from an image, the processor 12 may obtain the user pressure PR(t) from a wearable sensor 20 (for example, a strain sensor) worn by the user.

### (6-2) Second Modification

The second modification will be described.

The second modification is an example in which the user tempo is taken into consideration in addition to the user position and user velocity in evaluating motion (S1112).

The user tempo is the tempo of the beauty motion.

### (6-2-1) Overview of Second Modification

The overview of the second modification will be described.

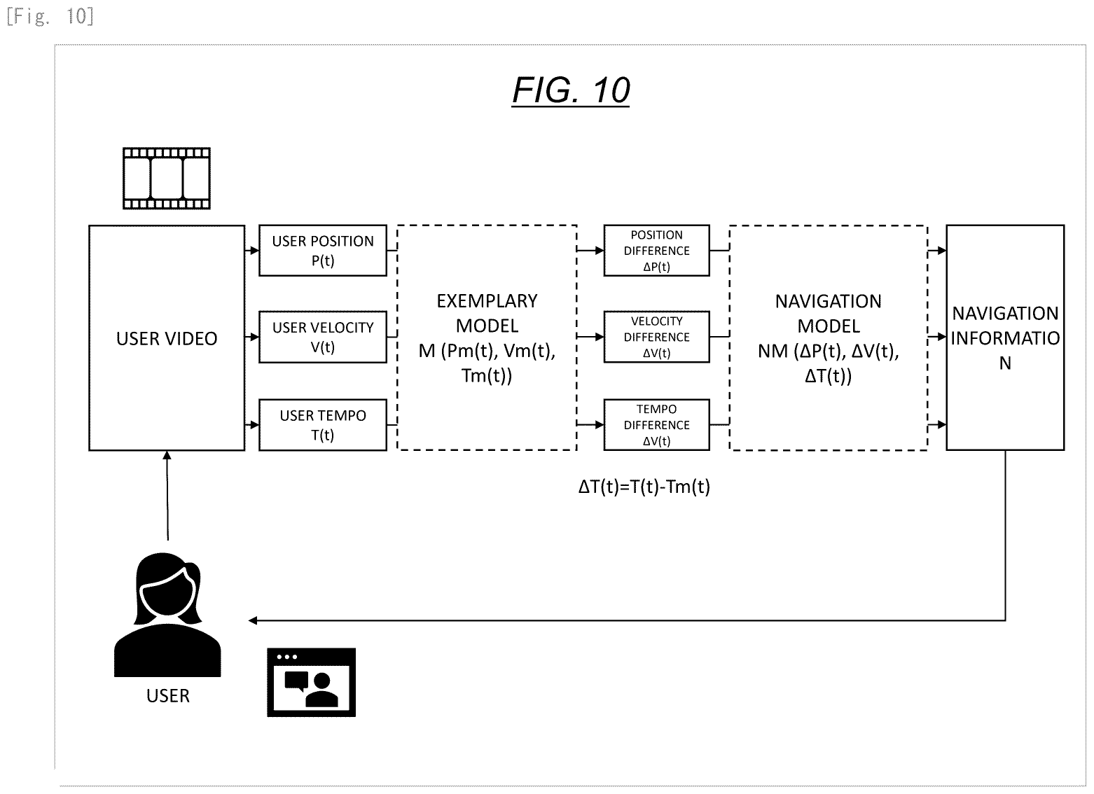

FIG. 10 is a diagram illustrating an overview of the second modification.

As shown in FIG. 9, by analyzing the user video, the user position P(t), user velocity V(t), and user tempo T(t) in each frame F(t) of the user video are identified.

By inputting the user position P(t), user velocity V(t), and user tempo T(t) into the exemplary model M (Pm(t), Vm(t), Tm(t)), a position difference ΔP(t), a velocity difference ΔV(t), and a motion difference ΔT(t) between the user tempo T(t) and the exemplary tempo Tm(t) (hereinafter referred to as the “tempo difference”) are obtained.

Navigation information is obtained by inputting the position difference ΔP(t), the velocity difference ΔV(t), and the tempo difference ΔT(t) into the navigation model NM(ΔP(t), ΔV(t), ΔT(t)).

The navigation information is presented to a user.

### (6-2-2) Information Processing of Second Modification

The information processing of the second modification will be described.

The trigger for starting the process of the second modification is the same as that shown in FIG. 6.

The client apparatus 10 acquires a user video (S1110) in the same manner as in FIG. 6.

After step S1110, the client apparatus 10 executes analyzing image (S1111).

Specifically, the processor 12 analyzes the user video to recognize, for each frame constituting the user video, the beauty target part of the user and the user's hand (for example, the fingertips).

For each frame F(t), the processor 12 identifies the beauty target part based on the coordinates of each beauty target part of the user.

The processor 12 identifies the position of the user's hand that is included in the target area in the frame F(t) as the user position P(t).

The processor 12 calculates the user velocity V(t) based on the amount of displacement (P(t+1)-P(t)) of the user position between frames F(t) and F(t+1).

A first example of step S1110 in the second modification will be described.

The processor 12 calculates the user tempo T(t) based on the position P(t) and the acceleration A(t).

A second example of step S1110 in the second modification will be described.

The processor 12 calculates a user tempo T(t) based on the sequence of the user's hand movements and the number of such movements.

After step S1111, the client apparatus 10 executes evaluating motion (S1112).

Specifically, the memory 11 stores an exemplary model M.

In the exemplary model M, an exemplary motion is described.

The exemplary motion is defined by an exemplary position Pm(t), an exemplary velocity Vm(t), and an exemplary tempo Tm(t).

The processor 12 refers to the exemplary model M to calculate the position difference ΔP(t) which is the difference between the user position P(t) and the exemplary position Pm(t).

The processor 12 refers to the exemplary model M to calculate a velocity difference ΔV(t) which is the difference between the user velocity V(t) and the exemplary velocity Vm(t).

The processor 12 refers to the exemplary model M to calculate a tempo difference ΔT(t) which is the difference between the user tempo T(t) and the exemplary tempo Tm(t).

The memory 11 stores a time-series score model.

The time-series score model describes the correlation between the evaluation results of the motion (for example, the position difference ΔP(t), the velocity difference ΔV(t), and the tempo difference ΔT(t)) and the time-series motion scores.

When the processor 12 inputs the position difference ΔP(t) to the time-series score model, the score model outputs a time-series position score corresponding to the position difference ΔP(t).

When the processor 12 inputs the velocity difference ΔV(t) to the time-series score model, the score model outputs a time-series velocity score corresponding to the velocity difference ΔV(t).

When the processor 12 inputs the tempo difference ΔT(t) to the time-series score model, the score model outputs a time-series tempo score corresponding to the tempo difference ΔT(t).

After step S1112, the client apparatus 10 executes navigation (S1113).

A first example of step S1113 in the second modification will be described.

The first example of step S1113 in the second modification is an example in which an image is used as navigation information.

The memory 11 stores a navigation model NM.

The navigation model NM describes the correlation between the combination of the position difference ΔP(t), the velocity difference ΔV(t), and the tempo difference ΔT(t) and the navigation information.

The processor 12 inputs the position difference ΔP(t), velocity difference ΔV(t), and tempo difference ΔT(t) obtained in step S1112 into the navigation model NM, thereby generating navigation information corresponding to the combination of the position difference ΔP(t), velocity difference ΔV(t), and tempo difference ΔT(t).

The processor 12 displays a screen P1111 (FIG. 8) on the display while the beauty motion is performed.

A second example of step S1113 in the second modification example is similar to the second example of step S1113 in FIG. 6.

The first and second examples of step S1113 in the second modification may be combined.

The memory 11 stores a navigation model NM.

The navigation model NM describes the correlation between the combination of the position difference ΔP(t), the velocity difference ΔV(t), and the tempo difference ΔT(t) and the sound conversion parameters.

The processor 12 inputs the position difference ΔP(t), velocity difference ΔV(t), and tempo difference ΔT(t) obtained in step S1112 into the navigation model NM, thereby generating sound conversion parameters corresponding to the combination of the position difference ΔP(t), velocity difference ΔV(t), and tempo difference ΔT(t).

The memory 11 stores predetermined sound information (for example, sound information to be reproduced while a beauty motion is performed).

The processor 12 generates converted sound information by converting sound information (an example of “sound information”) using the sound conversion parameters.

The processor 12 outputs the converted sound information from a speaker.

After step S1113, the client apparatus 10 executes recommendation (S1114).

Specifically, the memory 11 stores an overall motion score model.

The overall motion score model describes the correlation between the overall motion score and a combination of the overall position difference ΔP(t), velocity difference ΔV(t), and tempo difference ΔT(t) of the user video.

The memory 11 stores a recommendation model.

In the recommendation model, correlations between combinations of the overall position difference ΔP(t), velocity difference ΔV(t), and tempo difference ΔT(t) of the user video and recommendation information are described.

When the user operates the operation object B11120, the processor 12 inputs the combination of the position difference ΔP(t), velocity difference ΔV(t), and tempo difference ΔT(t) of the entire user video obtained in step S1112 into the overall motion score model, and determines an overall motion score corresponding to the combination of the position difference ΔP(t), velocity difference ΔV(t), and tempo difference ΔT(t).

The processor 12 inputs the combination of the position difference ΔP(t), velocity difference ΔV(t), and tempo difference ΔT(t) of the entire user video obtained in step S1112 into the recommendation model, and generates recommendation information corresponding to the combination of the position difference ΔP(t), velocity difference ΔV(t), and tempo difference ΔT(t).

The processor 12 displays a screen P1112 (FIG. 7) on the display.

After step S1114, the client apparatus 10 executes update request (S1115) in the same manner as in FIG. 6.

After step S1115, the server 30 executes updating database (S1130) in the same manner as in FIG. 6.

### (6-2-3) Summary of Second Modification

According to the second modification, navigation information corresponding to a combination of the position, velocity, and tempo of each of the user motion target parts is presented to the user.

This allows the user to perform beauty motion while taking into account the navigation information.

As a result, users who become customers interested in beauty can be given a greater incentive to continue beauty activities.

In particular, the second modification is particularly suitable when it is preferable to vary the velocity depending on the part of the body being treated, or when it is preferable to gradually vary the acceleration locally and sequentially even for the same beauty target part (for example, when the beauty motion is a massage).

More specifically, if the beauty motion involves moving the cheek in a circular motion, when the hands are on the upper part of the cheek during the latter part of the treatment, the motion of lifting the cheek is guided slowly, or if the hand is required to rotate three times, the third motion is made slower.

### (6-3) Third Modification

The third modification will be described.

The third modification is an example in which evaluating motion (S1112) takes into account the user acceleration in addition to the user position and user velocity.

### (6-3-1) Overview of Third Modification

The overview of the third modification will be described.

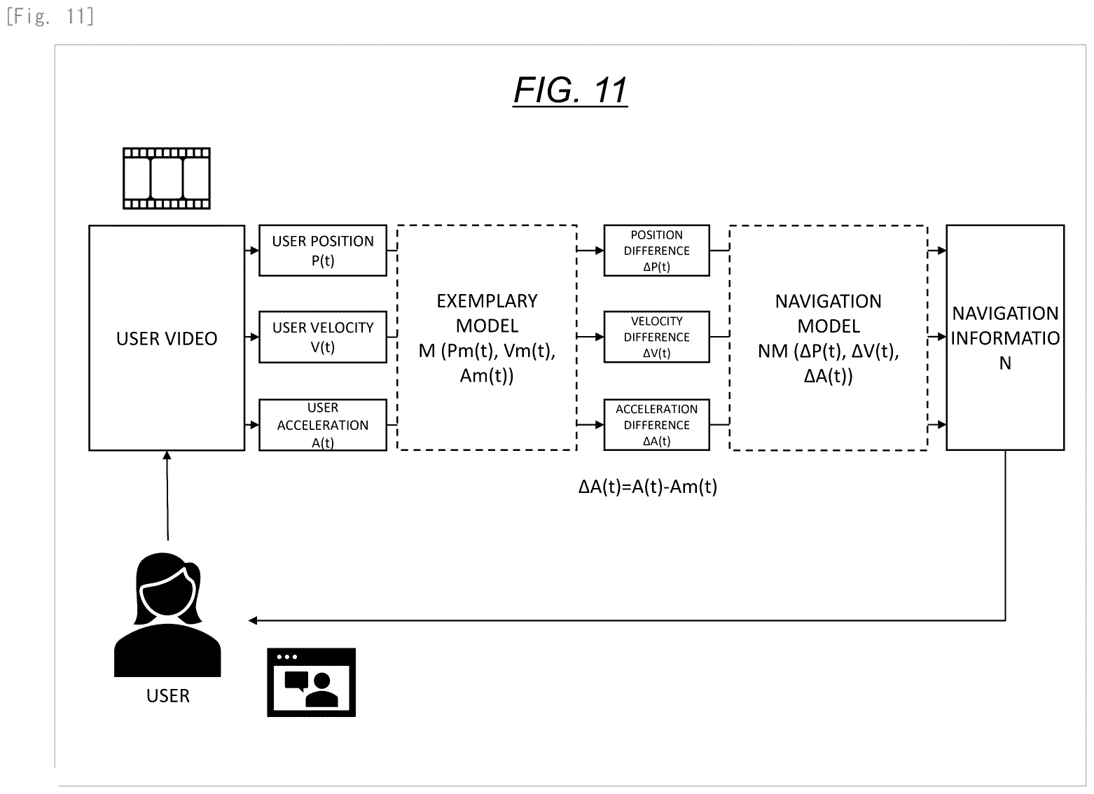

FIG. 11 is a diagram illustrating an overview of the third modification.

As shown in FIG. 11, by analyzing the user video, the user position P(t), user velocity V(t), and the acceleration of the user's hand (hereinafter referred to as “user acceleration”) A(t) in each frame F(t) of the user video are identified.

By inputting the user position P(t), user velocity V(t), and user acceleration A(t) into the exemplary model M (Pm(t), Vm(t), Am(t)), the position difference ΔP(t), the velocity difference ΔV(t), and the motion difference ΔA(t) between the user acceleration A(t) and the model acceleration Am(t) (hereinafter referred to as the “acceleration difference”) are obtained.

Navigation information is obtained by inputting the position difference ΔP(t), the velocity difference ΔV(t), and the acceleration difference ΔA(t) into the navigation model NM(ΔP(t), ΔV(t), ΔA(t)).

The navigation information is presented to a user.

### (6-3-2) Information Processing of Third Modification

The information processing of the third modification will be described.

The client apparatus 10 executes acquiring user video (S1110) in the same manner as in FIG. 6.

After step S1110, the client apparatus 10 executes analyzing image (S1111).

Specifically, the processor 12 analyzes the user video to recognize, for each frame F(t) constituting the user video each beauty target part of the user and the user's hand (for example, fingertips).

For each frame F(t), the processor 12 identifies the beauty target part based on the coordinates of each beauty target part of the user.

The processor 12 identifies the position of the user's hand that is included in the target area in the frame F(t) as the user position P(t).

The processor 12 calculates the user velocity V(t) based on the amount of displacement (P(t+1)-P(t)) of the user position between frames F(t) and F(t+1).

The processor 12 calculates the user acceleration A(t) based on the amount of change in the user velocity (V(t+1)-V(t)) between each frame F(t) and F(t+1).

After step S1111, the client apparatus 10 executes evaluating motion (S1112).

Specifically, the memory 11 stores an exemplary model M.

In the exemplary model M, an exemplary motion is described.

The exemplary motion is defined by an exemplary position Pm(t), an exemplary velocity Vm(t), and an exemplary acceleration Am(t).

The processor 12 refers to the exemplary model M to calculate the position difference ΔP(t) which is the difference between the user position P(t) and the exemplary position Pm(t).

The processor 12 refers to the exemplary model M to calculate a velocity difference ΔV(t) which is the difference between the user velocity V(t) and the exemplary velocity Vm(t).

The processor 12 refers to the exemplary model M to calculate an acceleration difference ΔA(t), which is the difference between the user acceleration A(t) and the model acceleration Am(t).

The memory 11 stores a time-series score model.

The time-series score model describes the correlation between the evaluation results of the motion (for example, the position difference ΔP(t), the velocity difference ΔV(t), and the acceleration difference ΔA(t)) and the time-series motion score.

When the processor 12 inputs the position difference ΔP(t) to the time-series score model, the score model outputs a time-series position score corresponding to the position difference ΔP(t).

When the processor 12 inputs the velocity difference ΔV(t) to the time-series score model, the score model outputs a time-series velocity score corresponding to the velocity difference ΔV(t).

When the processor 12 inputs the acceleration difference ΔA(t) to the time-series score model, the score model outputs a time-series pressure score corresponding to the acceleration difference ΔA(t).

After step S1112, the client apparatus 10 executes navigation (S1113).

A first example of step S1113 in the third modification will be described.

The first example of step S1113 in the third modification is an example in which an image is used as navigation information.

The memory 11 stores a navigation model NM.

The navigation model NM describes the correlation between the combination of the position difference ΔP(t), the velocity difference ΔV(t), and the acceleration difference ΔA(t) and the navigation information.

The processor 12 inputs the position difference ΔP(t), velocity difference ΔV(t), and acceleration difference ΔA(t) obtained in step S1112 into the navigation model NM, thereby generating navigation information corresponding to the combination of the position difference ΔP(t), velocity difference ΔV(t), and acceleration difference ΔA(t).

The processor 12 displays a screen P1111 (FIG. 8) on the display while the beauty motion is performed.

A second example of step S1113 in the third modification is similar to the second example of step S1113 in FIG. 6.

The first and second examples of step S1113 in the third modification may be combined.

The memory 11 stores a navigation model NM.

The navigation model NM describes the correlation between the combination of the position difference ΔP(t), the velocity difference ΔV(t), and the acceleration difference ΔA(t) and the sound conversion parameters.

The processor 12 inputs the position difference ΔP(t), velocity difference ΔV(t), and acceleration difference ΔA(t) obtained in step S1112 into the navigation model NM, thereby generating sound conversion parameters corresponding to the combination of the position difference ΔP(t), velocity difference ΔV(t), and acceleration difference ΔA(t).

The memory 11 stores predetermined sound information (for example, information to be reproduced while a beauty motion is performed).

The processor 12 generates converted sound information by converting sound information (an example of “sound information”) using the sound conversion parameters.

The processor 12 outputs the converted sound information from a speaker.

After step S1113, the client apparatus 10 executes recommendation (S1114).

Specifically, the memory 11 stores an overall motion score model.

The overall motion score model describes the correlation between the overall motion score and a combination of the overall position difference ΔP(t), velocity difference ΔV(t), and acceleration difference ΔA(t) of the user video.

The memory 11 stores a recommendation model.

In the recommendation model, a correlation between a combination of the overall position difference ΔP(t), velocity difference ΔV(t), and acceleration difference ΔA(t) of the user video and recommendation information is described.

When the user operates the operation object B11120, the processor 12 inputs the combination of the position difference ΔP(t), velocity difference ΔV(t), and acceleration difference ΔA(t) of the entire user video obtained in step S1112 into the overall motion score model, and determines an overall motion score corresponding to the combination of the position difference ΔP(t), velocity difference ΔV(t), and acceleration difference ΔA(t).

The processor 12 inputs the combination of the position difference ΔP(t), velocity difference ΔV(t), and acceleration difference ΔA(t) of the entire user video obtained in step S1112 into the recommendation model, and generates recommendation information corresponding to the combination of the position difference ΔP(t), velocity difference ΔV(t), and acceleration difference ΔA(t).

The processor 12 displays a screen P1112 (FIG. 7) on the display.

After step S1114, the client apparatus 10 executes update request (S1115) in the same manner as in FIG. 6.

After step S1115, the server 30 executes updating database (S1130) in the same manner as in FIG. 6.

### (6-3-3) Summary of Third Modification

According to the third modification, navigation information corresponding to a combination of the position, velocity, and acceleration of each of the user motion target parts is presented to the user.

This allows the user to perform beauty motion while taking into account the navigation information.

As a result, users who become customers interested in beauty can be given a greater incentive to continue beauty activities.

In particular, the third modification is particularly suitable when it is preferable to perform treatment at a constant velocity regardless of the technique of the beauty motion and the target area of the operation (for example, when the beauty motion is applying lotion or milk).

### (6-4) Forth Modification

The fourth modification will be described.

The fourth modification is an example in which an avatar image is used as navigation information.

### (6-4-1) Overview of Forth Modification

The overview of the fourth modification will be described.

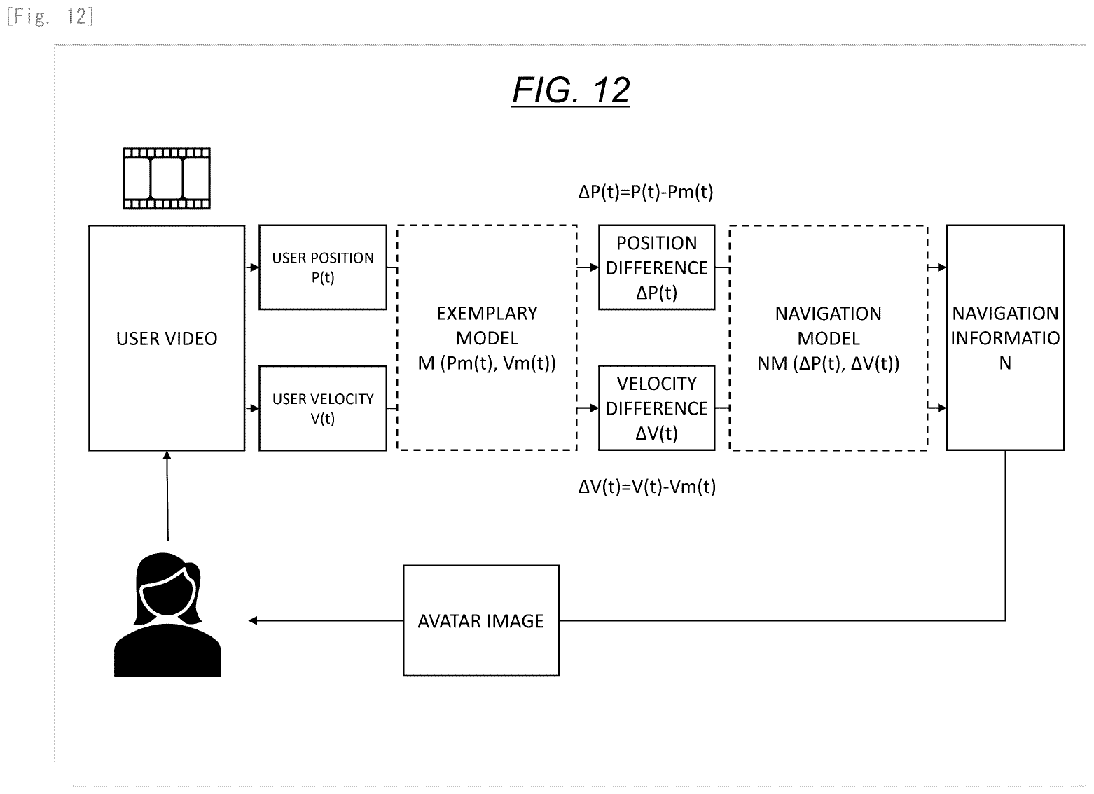

FIG. 12 is a diagram illustrating an overview of the fourth modification.

As shown in FIG. 12, by analyzing the user video of the beauty motion, the user's position P(t) and the user's velocity V(t) in each frame F(t) of the user video are identified.

By inputting the user position P(t) and the user velocity V(t) into the exemplary model M(Pm(t), Vm(t)), the position difference ΔP(t) and the velocity difference ΔV(t) are obtained.

Navigation information is obtained by inputting the position difference ΔP(t) and the velocity difference ΔV(t) into the navigation model NM(ΔP(t), ΔV(t)).

The navigation information is presented to the user as an avatar image.

### (6-4-2) Information Processing of the Fourth Modification

The information processing of the fourth modification will be described.

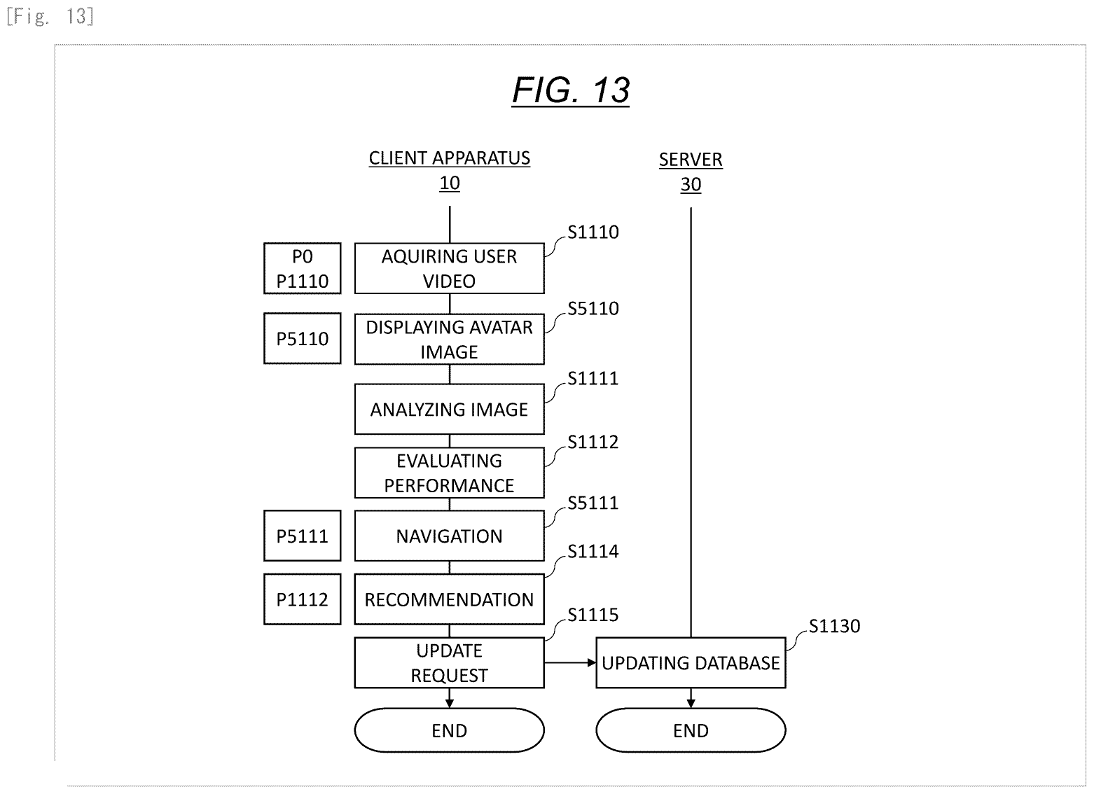

FIG. 13 is a sequence diagram of information processing corresponding to the fourth modification.

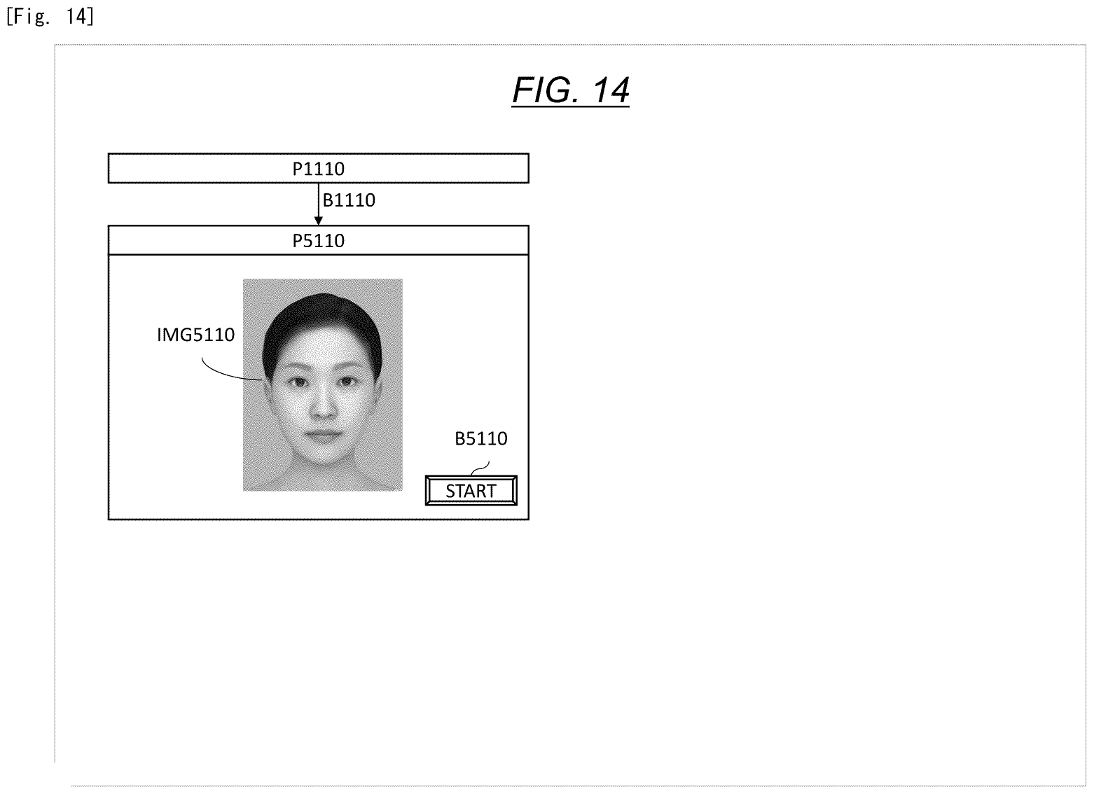

FIG. 14 is a view showing an example of a screen displayed in the information processing of FIG. 13.

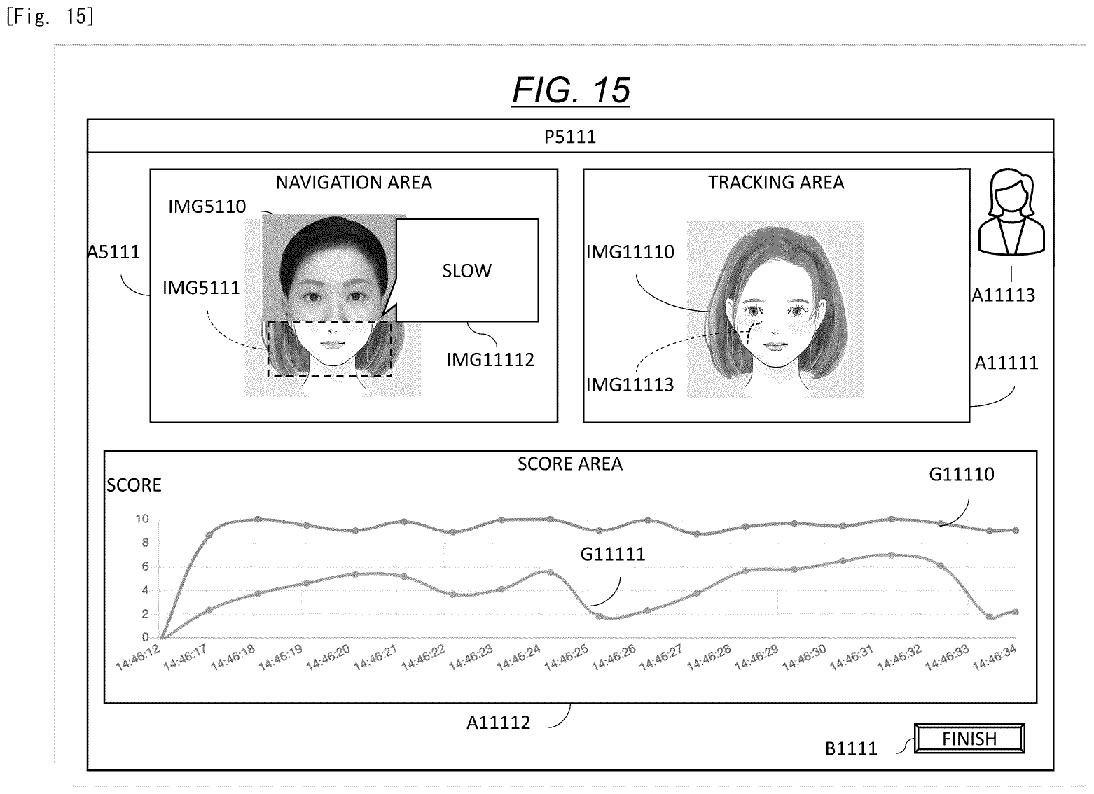

FIG. 15 is a view showing an example of a screen displayed in the information processing of FIG. 13.

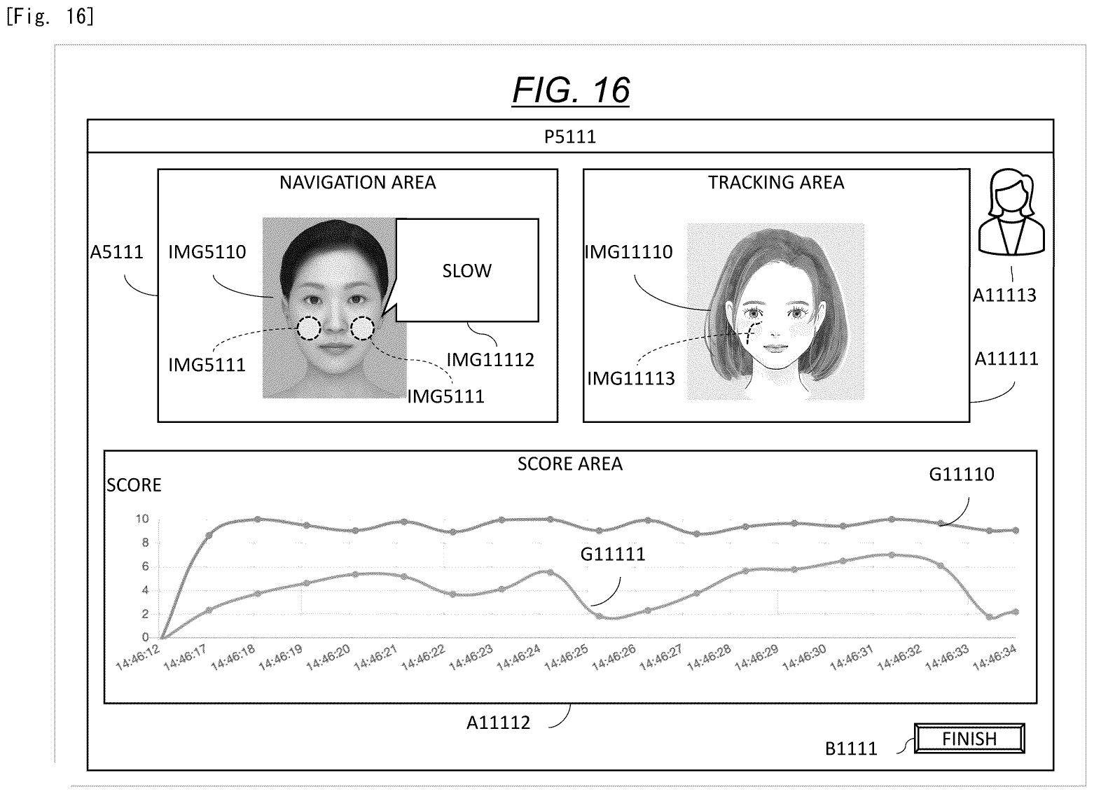

FIG. 16 is a diagram showing an example of a screen displayed in the information processing of FIG. 13.

The trigger for starting the process in FIG. 13 is the same as in FIG. 6.

As shown in FIG. 13, the client apparatus 10 executes acquiring user video (S1110) in the same manner as in FIG. 6.

After step S1110, the client apparatus 10 executes displaying avatar image (S5110).

Specifically, the processor 12 displays a screen P5110 (FIG. 14) on the display.

The screen P5110 includes an operation object B5110 and an image object IMG5110.

The avatar image IMG5110 is one of the following:
images stored in the memory 11; and
images generated according to a user instruction of the user.

The operation object B5110 is an object that receives a user instruction to start navigation.

After step S5110, the client apparatus 10 executes the steps from analyzing image (S1111) to evaluating motion (S1112) in the same manner as in FIG. 6.

After step S1112, the client apparatus 10 executes navigation (S5111).

A first example of step S5111 will be described.

The first example of step S5111 is an example in which the user's face is revealed by erasing pixels of the avatar image at positions where beauty motions have been performed.

Specifically, the processor 12 erases pixels of the avatar image corresponding to the coordinates of the user's hand identified in step S1111, and replaces them with pixels of the user video IMG5111.

The processor 12 displays a screen P5111 (FIG. 15) on the display.

The screen P5111 includes display objects A5111 and A11111 to A11113, and operation object B1111.

The display objects A11111 to A11113 and operation object B1111 are the same as those in FIG. 8.

The display object A5111 displays image objects IMG11112, IMG5110, and IMG5111.

The image object IMG11112 is the same as in FIG. 8.

The image object IMG5111 is part of the user image sequence that has been replaced by processor 12.

In a first example of step S5111, as shown in FIG. 14, before the start of the beauty motion, the avatar image IMG5110 is displayed, and a user video is not displayed.

When the user performs a beauty motion, pixels of the user video (that is, the user's face) are revealed at the positions where the beauty motion was performed, as shown in FIG. 15.

A second example of step S5111 will be described.

The second example of step S5111 is an example in which makeup is applied to the position on the avatar image where the beauty motion has been performed by changing the color of the pixel of the avatar image at the position where the beauty motion has been performed.

Specifically, the processor 12 changes the color of the pixel in the avatar image that corresponds to the coordinates of the user's hand identified in step S1111.

The processor 12 displays a screen P5111 (FIG. 16) on the display.

The screen P5111 includes display objects A5111, A11111 to A11113, and operation object B1111.

The display objects A11111 to A11113 and operation object B1111 are the same as those in FIG. 8.

The display object A5111 displays image objects IMG11112, IMG5110, and IMG5111.

The image object IMG11112 is the same as in FIG. 8.

The image object IMG5111 is a pixel whose color has been changed by processor 12.

In a second example of step S5111, as shown in FIG. 14, the avatar image IMG5110 is displayed, and a user video is not displayed before the start of the beauty motion.

When the user performs a beauty motion, as shown in FIG. 16, the color of pixel IMG5111 of the avatar image IMG5110 changes at the position where the beauty motion has been performed (that is, makeup is applied to the avatar image).

After step S5111, the client apparatus 10 executes recommendation (S1114) to update request (S1115) in the same manner as in FIG. 6.

After step S1115, the server 30 executes updating database (S1130) in the same manner as in FIG. 6.

### (6-4-3) Summary of Forth Modification

According to the fourth modification, an avatar image is superimposed on the user video IMG11110, and pixels of the avatar image at the position where the beauty motion was performed are changed.

This allows the user to perform beauty motion while enjoying the changes in the avatar image.

As a result, users who become customers interested in beauty can be given a greater incentive to continue beauty activities.

According to the fourth modification, pixels of the avatar image at the position where the beauty motion was performed are erased to reveal an image of the user's face at the position where the beauty motion was performed.

This allows the user to perform beauty motion while enjoying the changes in the avatar image.

As a result, users who become customers interested in beauty can be given a greater incentive to continue beauty activities.

According to the fourth modification, the makeup is applied to the avatar image at the position where the beauty motion has been performed by changing the color of the pixel of the avatar image at the position where the beauty motion has been performed.

This allows the user to perform beauty motion while enjoying the changes in the avatar image.

As a result, users who become customers interested in beauty can be given a greater incentive to continue beauty activities.

In the fourth modification, an example has been described in which an avatar image is superimposed on the user video IMG11110, but the scope of the fourth modification is not limited to this.

The fourth modification may also be applied to the case where both the user video IMG11110 and the avatar image are displayed.

In the fourth modification, an example in which an avatar image is displayed has been described, but the scope of the fourth modification is not limited to this.

The fourth modification may also be applied to an example in which an avatar image is displayed and a sound of the avatar image (an example of “navigation information”) is output.

### (6-5) Fifth Modification

The fifth modification will be described.

The fifth modification is an example in which a beauty motion is evaluated in accordance with a scenario.

### (6-5-1) Overview of Fifth Modification

The overview of the fifth modification will be described.

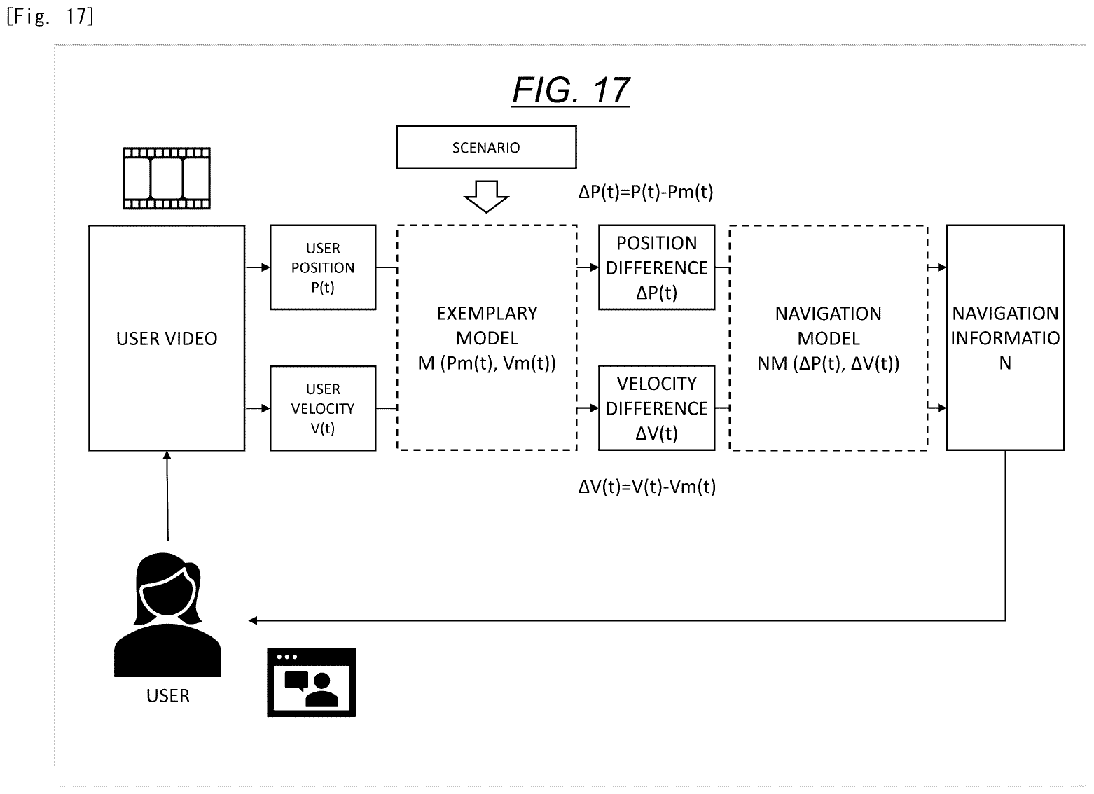

FIG. 17 is a diagram illustrating an overview of the fifth modification.

As shown in FIG. 17, by analyzing the user video of the beauty motion, the user's position P(t) and the user's velocity V(t) in each frame F(t) of the user video are identified.

t is an example of information for identifying a frame.

By inputting the user position P(t) and user velocity V(t) into the exemplary model M(Pm(t), Vm(t)), a motion difference (hereinafter referred to as the “position difference”) ΔP(t) between the user position P(t) and the exemplary position Pm(t) and a motion difference (hereinafter referred to as the “velocity difference”) ΔV(t) between the user velocity V(t) and the exemplary velocity Vm(t) can be obtained in accordance with a predetermined scenario.

Navigation information is obtained by inputting the position difference ΔP(t) and the velocity difference ΔV(t) into the navigation model NM(ΔP(t), ΔV(t)).

The navigation information is presented to a user.

### (6-5-2) Information Processing of Fifth Modification

The information processing of the fifth modification will be described.

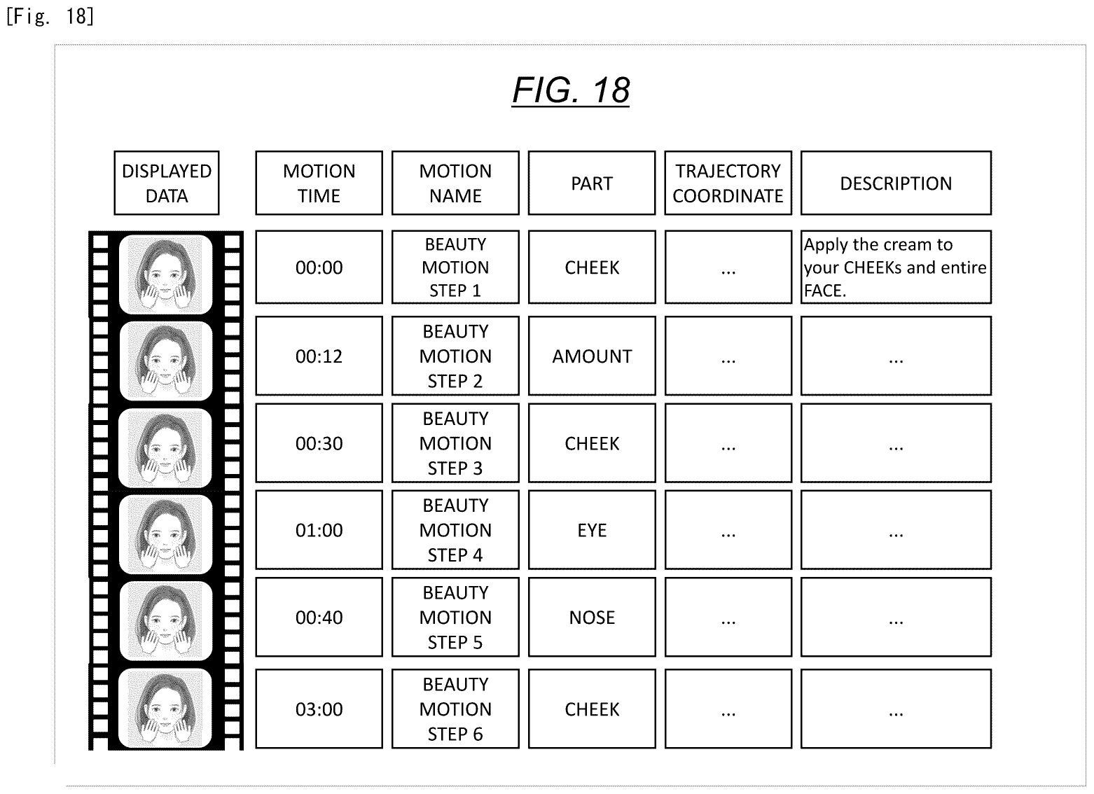

FIG. 18 is a sequence diagram of information processing of the fifth modification.

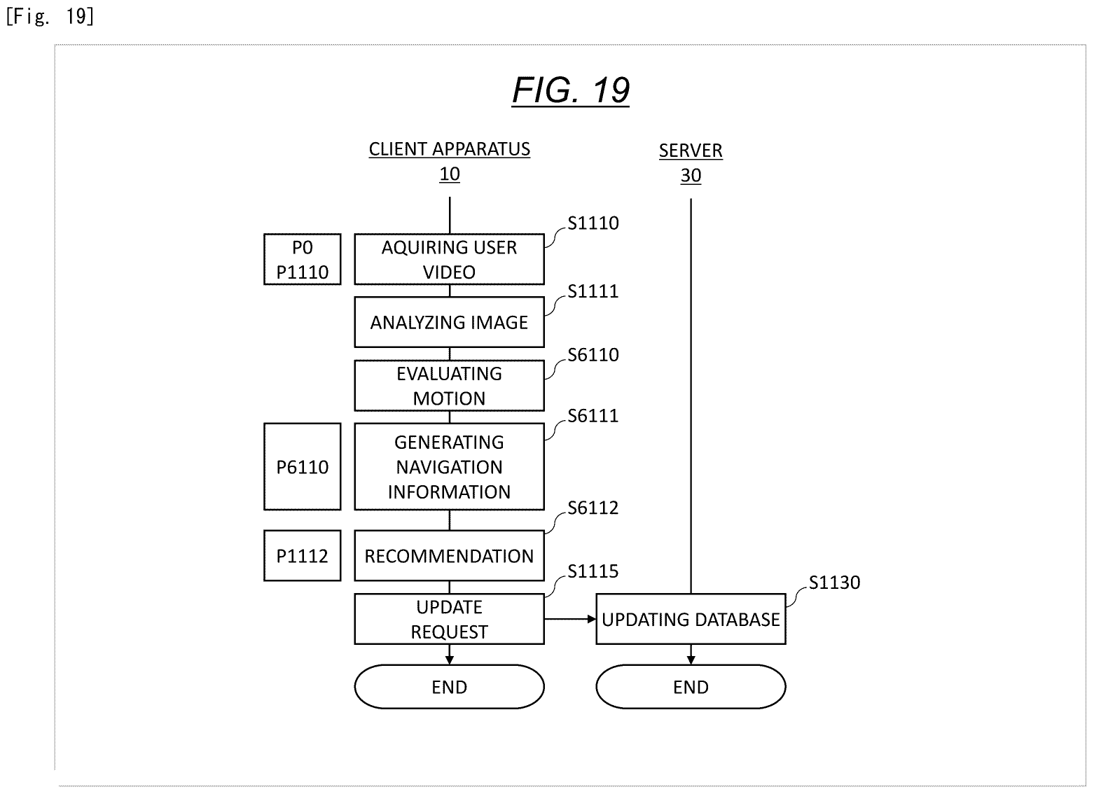

FIG. 19 is an explanatory diagram of the scenario of FIG. 17.

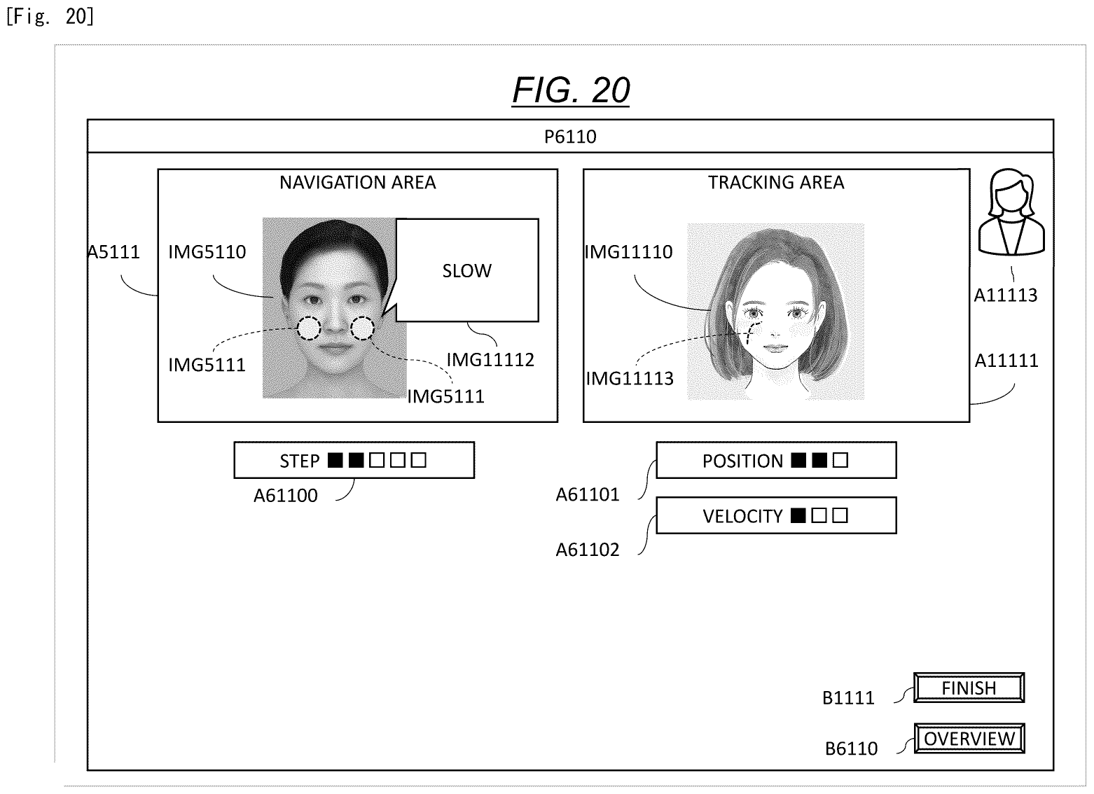

FIG. 20 is a view showing an example of a screen displayed in the information processing of FIG. 18.

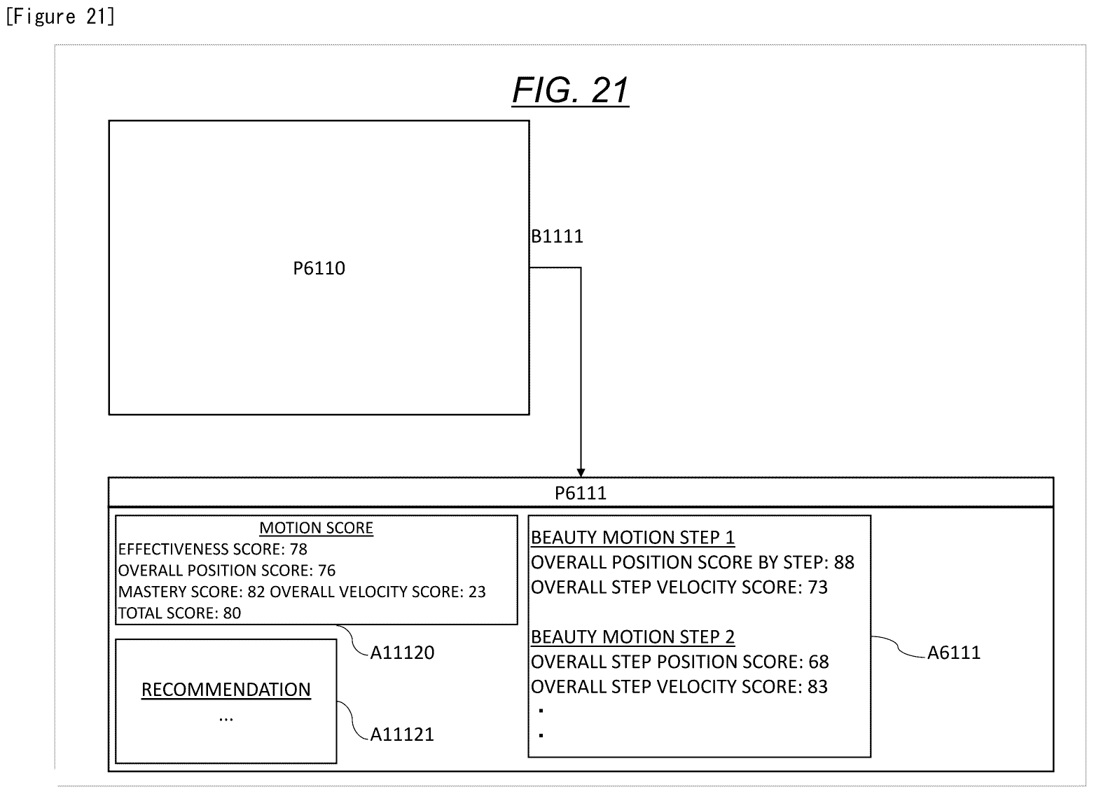

FIG. 21 is a view showing an example of a screen displayed in the information processing of FIG. 18.

As shown in FIG. 19, the client apparatus 10 executes acquiring user video (S1110) and analyzing image (S1111) in the same manner as in FIG. 6.

After step S1111, the client apparatus 10 executes evaluating motion (S6110).

Specifically, a plurality of exemplary models M are stored in the memory 11.

Each exemplary model M corresponds to one scenario.

The scenario describes exemplary motion in chronological order for each part of the user's face and for each type of beauty motion.

That is, in each exemplary model M, an exemplary motion corresponding to a scenario is described.

The types of beauty motion include, for example, at least one of the following:
how to move hands (for example, move in a straight line, lift cheek, move in a circular motion, so as like); and
how to apply force with hand (for example, pushing in at one point).

A scenario includes multiple sections.

In each section, beauty motion steps constituting a series of beauty motions are defined (FIG. 19).

A combination of multiple beauty motion steps forms a series of beauty motion.

The beauty motion steps included in each section may be common or different.

When the beauty motion steps included in each section are common, it means that the multiple sections repeat the common beauty motion steps.

In the exemplary model M, an element of the exemplary motion is defined for each beauty motion step.

The elements of the exemplary motion include at least one of the motion time, motion name, part, trajectory coordinate, description, and displayed data.

The processor 12 refers to the exemplary model M and calculates the position difference ΔP(t) that is the difference between the user position P(t) and the exemplary position Pm(t) for each beauty motion step.

The processor 12 refers to the exemplary model M and calculates the velocity difference ΔV(t) which is the difference between the user velocity V(t) and the model velocity Vm(t) for each beauty motion step.

The memory 11 stores a time-series score model.

The time-series score model describes the correlation between the evaluation results of the motion for each beauty motion step (for example, the position difference ΔP(t) and the velocity difference ΔV(t)) and the time-series motion score.

When the processor 12 inputs the position difference ΔP(t) to the score model, the score model outputs a time-series position score for each beauty motion step corresponding to the position difference ΔP(t).

When the processor 12 inputs the velocity difference ΔV(t) to the score model, the score model outputs a time-series velocity score for each beauty motion step corresponding to the velocity difference ΔV(t).

After step S6110, the client apparatus 10 executes generating navigation information (S6111).

Specifically, the memory 11 stores a navigation model NM.

The navigation model NM describes the correlation between the combination of the position difference ΔP(t) and the velocity difference ΔV(t) and the navigation information.

The processor 12 inputs the position difference ΔP(t) and velocity difference ΔV(t) for each beauty motion step obtained in step S6110 into the navigation model NM, thereby generating navigation information for each beauty motion step corresponding to the combination of the position difference ΔP(t) and the velocity difference ΔV(t).

The processor 12 displays a screen P6110 (FIG. 20) on the display while the beauty motion is performed.

The screen P6110 includes display objects A5111, A11111, A11113, and A61100 to A61102, and operation object B6110.

The display objects A11111 and A11113 are the same as those in FIG. 8.

The display object A5111 is the same as that in FIG. 15.

The display object A61100 is an object that indicates the current beauty motion step relative to the overall beauty motion steps.

A display object A61101 is an object indicating a time-series position score.

The display object A61102 is an object that indicates a time-series velocity score.

The operation object B6110 is an object that accepts a user instruction for displaying an overview of the current beauty motion step.

After step S6111, the client apparatus 10 executes recommendation (S6112).

Specifically, the memory 11 stores an overall motion score model.

The overall motion score model describes the correlation between the combination of the position difference ΔP(t) and velocity difference ΔV(t) of the user video and the overall motion score for each beauty motion step.

The memory 11 stores a recommendation model.

In the recommendation model, a correlation between a combination of a position difference ΔP(t) and a velocity difference ΔV(t) of the user video and recommendation information is described for each beauty motion step.

When the user operates the operation object B11120, the processor 12 inputs the combination of the position difference ΔP(t), velocity difference ΔV(t), and acceleration difference ΔA(t) of the user video for each beauty motion step obtained in step S1112 into the overall motion score model, and determines an overall motion score for each beauty motion step (hereinafter referred to as the “step-by-step overall motion score”) corresponding to the combination of the position difference ΔP(t), velocity difference ΔV(t), and acceleration difference ΔA(t), and an overall motion score for the entire beauty motion including all beauty motion steps.

The processor 12 inputs the combination of the position difference ΔP(t), velocity difference ΔV(t), and acceleration difference ΔA(t) of the user video for each beauty motion step obtained in step S1112 into the recommendation model, and generates recommendation information corresponding to the combination of the position difference ΔP(t), velocity difference ΔV(t), and acceleration difference ΔA(t).

The processor 12 displays a screen P6111 (FIG. 21) on the display.

The screen P6111 includes display objects A11120 to A11121 and A6111.

The display objects A11120 to A11121 are the same as those in FIG. 7.

The display object A6111 is an object that displays the step-by-step overall motion score (for example, a step-by-step overall position score and a step-by-step overall velocity score).

After step S6112, the client apparatus 10 executes update request (S1115) in the same manner as in FIG. 6.

After step S1115, the server 30 executes updating database (S1130) in the same manner as in FIG. 6.

### (6-5-3) Summary of Fifth Modification

According to the fifth modification, a plurality of exemplary models M are used to generate navigation information.

Each exemplary model M corresponds to one scenario.

This makes it easy to add and change patterns of the beauty motion.

### (6-6) Sixth Modification

The sixth modification will be described.

The sixth modification is an example in which navigation information is changed corresponding to a combination of beauty motion and facial expressions.

### (6-6-1) Overview of Sixth Modification

The overview of the sixth modification will be described.

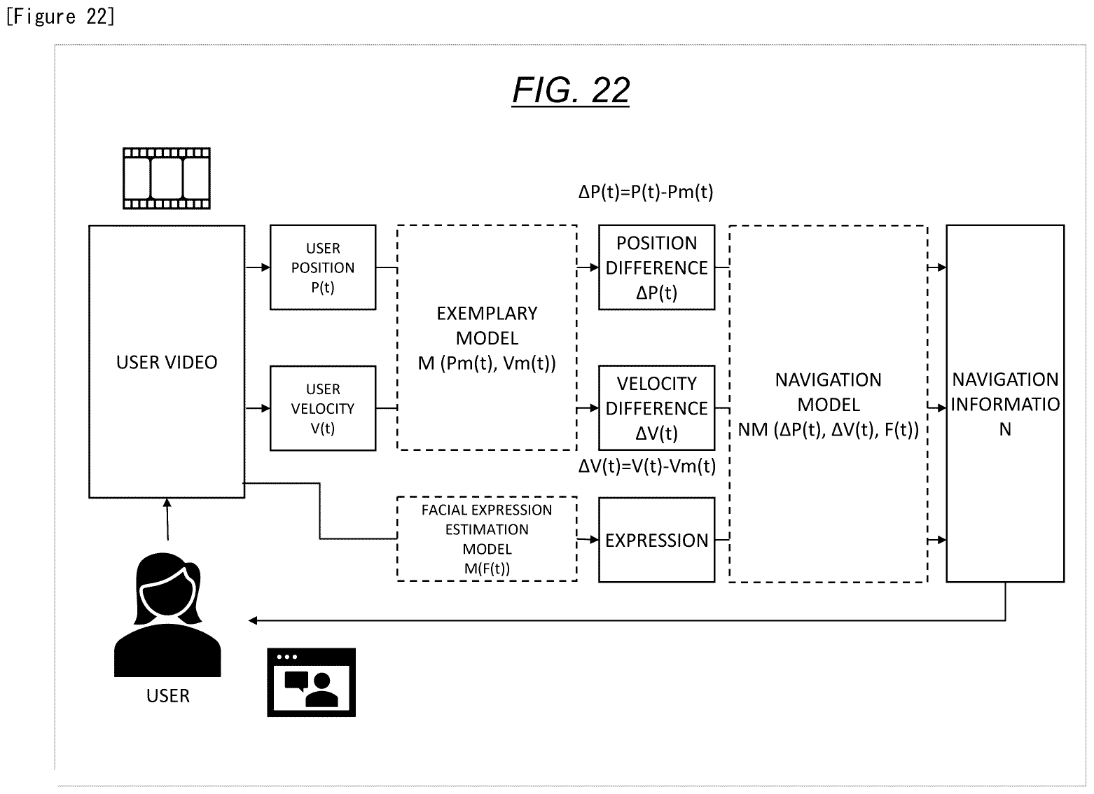

FIG. 22 is a diagram illustrating an overview of the sixth modification.

As shown in FIG. 22, by analyzing the user video, the user position P(t) and the user velocity V(t) are identified in the same manner as in the present embodiment (FIG. 3).

By inputting the user position P(t) and the user velocity V(t) into the exemplary model M(Pm(t), Vm(t)), the position difference ΔP(t) and the velocity difference ΔV(t) are obtained, as in the present embodiment (FIG. 3).

By inputting the user video into the facial expression evaluation model M(F(t)), the user's facial expressions F(t) along a time series are estimated.

Navigation information is obtained by inputting the position difference ΔP(t), the velocity difference ΔV(t), and F(t) into the navigation model NM(ΔP(t), ΔV(t), F(t)).

The navigation information is presented to a user.

### (6-6-2) Information Processing of Sixth Modification

The information processing of the sixth modification will be described.

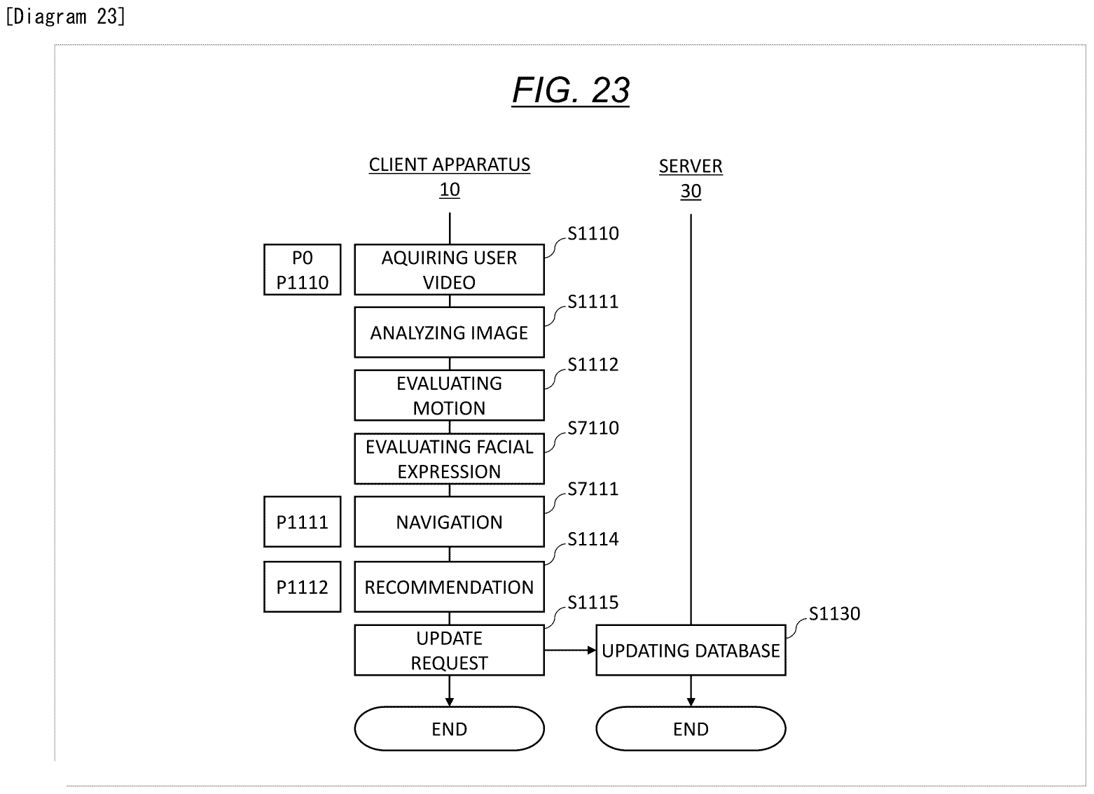

FIG. 23 is a sequence diagram of information processing of the sixth modification.

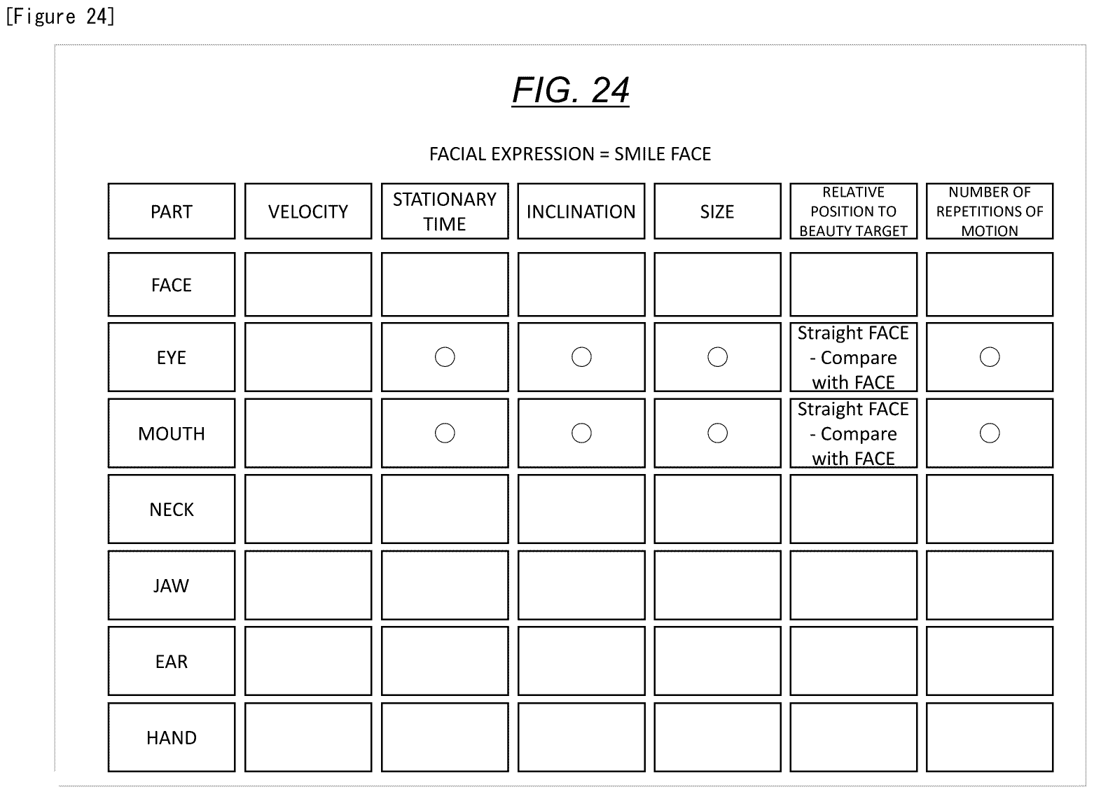

FIG. 24 is an explanatory diagram of a facial expression evaluation model (evaluation of the degree of smiling face) of the sixth modification.

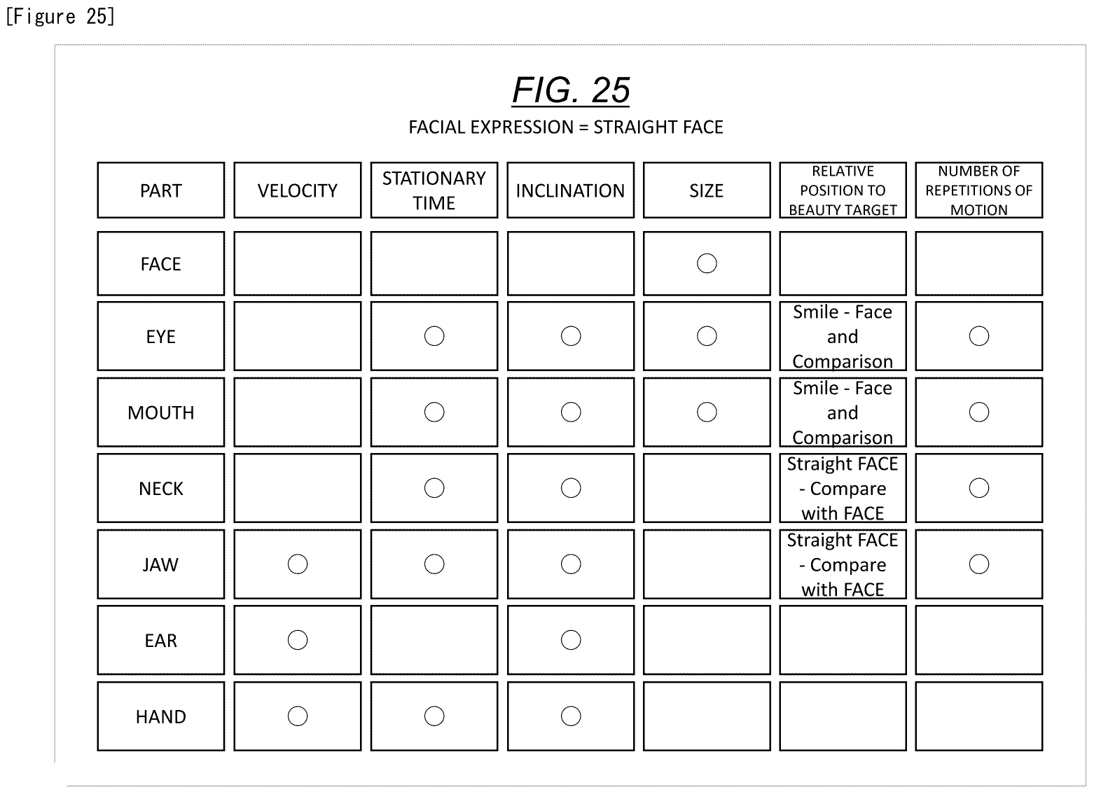

FIG. 25 is an explanatory diagram of a facial expression evaluation model (evaluation of the degree of seriousness of face) of the sixth modification.

As shown in FIG. 23, the client apparatus 10 executes acquiring user video (S1110) to evaluating motion (S1112) in the same manner as in FIG. 6.

After step S1112, the client apparatus 10 executes evaluating facial expression (S7110).

Specifically, the memory 11 stores a facial expression evaluation model M(F(t)).

The facial expression evaluation model M(F(t)) describes the correlation between the relative positional relationship of each part of the user's face (for example, eyebrows, eyes, and mouth) and the evaluation of the facial expression.

The evaluation of facial expression is the degree of emotion (for example, joy, anger, sadness, or happiness) that appears on the user's face.

For example, the evaluation of the facial expression is at least one of the degrees of smiling, the degree of seriousness, and the degree of unpleasantness.

The facial expression evaluation is an indicator of the user's subjective response to the beauty motion.

As shown in FIG. 24, when evaluating the degree of a smile, the evaluation target areas are the eyes and the mouth.

In assessing the eyes and mouth, the following values will be used as evaluation indices:
stationary time;
inclination;
size;
difference between the position of serious face and the position of the smile face (for example, the amount of change); and
number of repetitions of motion.

For example, the degree of the smile face is evaluated based on at least one of the changes in the position of the corners of the mouth and the degree of downward drooping of the corners of the eyes.

As an example, the degree of the smile face is evaluated as being high (that is, the user feels comfortable) in at least one of the following cases that:
the corners of the eyes go down; and
the corners of the mouth turn up.

As shown in FIG. 25, when evaluating the degree of the serious face, the evaluation target areas are the face, eyes, mouth, neck, chin, ears, and hands.

In face evaluation, the following values are used as evaluation target indexes:
size.

In assessing the eyes and mouth, the following values are used as the evaluation indices:
stationary time;
inclination;
size;
difference between the position of the serious face and the position of the smile face (for example, the amount of change); and
number of repetitions of motion.

In assessing the neck, the following values are used as evaluation indices:
stationary time;
inclination;
difference between the position of the serious face and the position of the smile face (for example, the amount of change); and
number of repetitions of motion.

In assessing the jaw, the following values are used as evaluation indices:
velocity;
stationary time;
inclination;
difference between the position of the serious face and the position of the smile face (for example, the amount of change); and
number of repetitions of motion.

In the ear evaluation, the following values are the evaluation target indexes:
velocity; and
inclination.

In assessing hands, the following values are used as evaluation indices:
velocity;
stationary time; and
inclination.

For example, the degree of the serious face is evaluated based on at least one of the manners in which the eyelids are opened, the change in the position of the eyebrows, and the shape of the mouth.

As an example, in at least one of the following cases, the degree of the serious face is evaluated to be high (that is, the user feels uncomfortable):
narrowing of the eyebrows;
squinting your eyes; and
pouting.

The processor 12 inputs the user video to the facial expression evaluation model M(F(t).

The facial expression evaluation model M(F(t) calculates the value of the evaluation target index for each evaluation target part corresponding to FIG. 24 or FIG. 25, and outputs the evaluation of the facial expression.

After step S7110, the client apparatus 10 executes navigation (S7111).

Specifically, the memory 11 stores a navigation model NM.

The navigation model NM describes the correlation between the combination of the position difference ΔP(t), the velocity difference ΔV(t), and the facial expression evaluation, and the navigation information.

The processor 12 generates navigation information corresponding to the combination of the position difference ΔP(t), the velocity difference ΔV(t), and the facial expression evaluation by inputting the position difference ΔP(t) and the velocity difference ΔV(t) obtained in step S1112 into the navigation model NM.

After step S7111, the client apparatus 10 executes recommendation (S1114) to update request (S1115) in the same manner as in FIG. 6.

After step S1115, the server 30 executes updating database (S1130) in the same manner as in FIG. 6.

### (6-6-3) Summary of Sixth Modification

According to the sixth modification, the navigation information presented to the user changes corresponding to the combination of the user's motion for each beauty target part and facial expression.

This makes it possible to present navigation information that satisfies the user as reflected in their facial expressions.

As a result, the user can be given an incentive to continue the beauty motion.

### (6-7) Seventh Modification

The seventh modification will be described.

The seventh modification is an example in which navigation information is presented in response to the motion of the head, neck, or face.

### (6-7-1) Overview of Seventh Modification

The seventh modification will be overview.

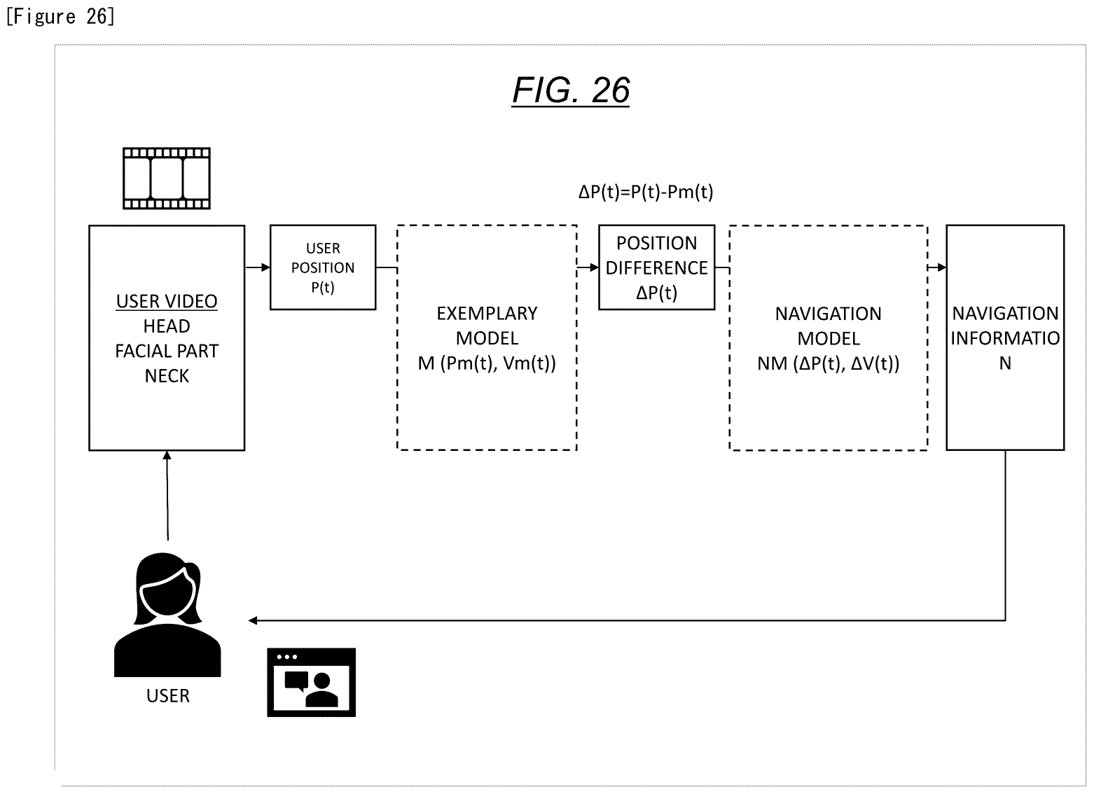

FIG. 26 is a diagram illustrating an overview of the seventh modification.

As shown in FIG. 26, by analyzing a user video of the beauty motion (motion of the head, neck, or face), a user position P(t) in each frame F(t) of the user video is identified.

t is an example of information for identifying a frame.

By inputting the user position P(t) into the exemplary model M(Pm(t)), a position difference ΔP(t) is obtained.

Navigation information is obtained by inputting the position difference ΔP(t) into the navigation model NM(ΔP(t), ΔV(t)).

The navigation information is presented to a user.

### (6-7-2) Information Processing of Seventh Modification

The information processing of the seventh modification will be described.

As shown in FIG. 6, the client apparatus 10 executes acquiring user video (S1110).

Specifically, the processor 12 displays a screen P0 (FIG. 7) on the display.

When the user operates the operation object B2, the processor 12 displays the screen P1110 on the display.

When the user aligns the position of his/her face with the guide of the display object A1110 and operates the operation object B1110, the camera 15 starts capturing the user video.

The processor 12 acquires the user video captured by the camera 15.

When the user performs a beauty motion after operating the operation object B1110, the user video includes an image of the beauty motion.

After step S1110, the client apparatus 10 executes analyzing image (S1111).

Specifically, the processor 12 analyzes the user video to recognize feature points of the beauty target part for each frame constituting the user video.

The beauty target part includes, for example, at least one of the following:
head;
eyebrow;
eye;
nose;
mouth;
cheek; and
neck.

For example, the beauty motion may include at least one of the following:
head motion (for example, looking up or down);
eyebrow motion (for example, looking up or down);
nose motion (for example, moving or keeping);
eye motion (for example, opening or closing);
mouth motion (for example, opening or closing);
cheek motion (for example, puffing out or hollowing); and
neck motion (for example, tilting the head or keeping the head straight).

After step S1111, the client apparatus 10 executes evaluating motion (S1112).

Specifically, the memory 11 stores an exemplary model M.

In the exemplary model M, an exemplary motion is described.

The exemplary motion is defined by an exemplary position Pm for each part of the head or face.

When the exemplary position Pm(t1) in frame t1 and the exemplary position P(t2) in frame t2 indicate the same position, this means that the position of the beauty motion is stationary from frame t1 to t2.

The processor 12 refers to the model M to calculate the position difference ΔP(t) which is the difference between the user position P(t) and the exemplary position Pm(t).

The memory 11 stores a time-series score model.

In the time-series score model, a correlation between the evaluation result of the motion (for example, the position difference ΔP(t)) and the time-series motion score is described.

When the processor 12 inputs the position difference ΔP(t) to the time-series score model, the score model outputs a time-series position score corresponding to the position difference ΔP(t).

After step S1112, the client apparatus 10 executes generating navigation information (S1113).

The memory 11 stores a navigation model NM.

The navigation model NM describes the correlation between the position difference ΔP(t) and the navigation information.

The processor 12 inputs the position difference ΔP(t) into the navigation model NM to generate navigation information corresponding to the position difference ΔP(t) obtained in step S1112.

A specific example of the navigation information is at least one of the first to third examples in step S1113.

After step S1113, the client apparatus 10 performs recommendation (S1114) to update request (S1115) in the same manner as in FIG. 6.

After step S1115, the server 30 executes updating database (S1130) in the same manner as in FIG. 6.

### (6-7-3) Summary of Seventh Modification

According to the seventh modification, navigation information (that is, navigation information for massaging the user's face without using hands) is presented to the user in accordance with the beauty motion for each part of the user's face.

This allows hands-free beauty motion to be performed taking into account the navigation information.

As a result, the user can be given an incentive to continue the beauty motion.

In the modification 7, an example is shown in which the position difference ΔP(t) of facial parts is input into the navigation model NM (that is, based on the position difference ΔP(t)) to generate navigation information, but the scope of the modification 7 is not limited to this.

The seventh modification is also applicable to an example in which navigation information is generated by inputting a combination of the position difference ΔP(t) and velocity difference ΔV(t) of facial parts into the navigation model NM (that is, based on the combination of the position difference ΔP(t) and velocity difference ΔV(t)).

### (7) Other Modifications

Other modifications will be described.

The memory 11 may be connected to the client apparatus 10 via a network NW.

The memory 31 may be connected to the server 30 via a network NW.

Each step of the above information processing can be executed by either the client apparatus 10 or the server 30.

For example, if the client apparatus 10 is capable of executing all the steps of the above-mentioned information processing, the client apparatus 10 functions as an information processing apparatus that operates standalone without transmitting requests to the server 30.

In the present embodiment, at least one of the following hand images may be used as the navigation image on screen P1111.

In this case, the processor 12 changes the image of the hand depending on the user position (for example, generates an image of the hand to show a hand movement suitable for cheek care at the timing when the cheek should be cared for).
previously captured image of the user's hand; and
previously registered computer graphics image of hand.

In the present embodiment, the navigation model NM may be provided for each of the user's concerns.

For example, in navigation (S1113), the processor 12 refers to the “skin concern” field of the user database to identify the user's skin concern information.

The processor 12 selects the navigation model NM corresponding to the identified skin concern information from among the navigation models NM stored in the memory 11.

The processor 12 uses the selected navigation model NM to generate navigation information.

In the present embodiment, the navigation model NM presents navigation information to the user using a navigation image.

However, the present invention is not limited to this.

This embodiment is also applicable to an example in which the navigation model NM presents navigation information to the user by vibration.

In the present embodiment, as shown in FIG. 6, an example has been shown in which recommendation (S1114) is executed after navigation (S1113), but the scope of the present embodiment is not limited to this.

This embodiment can also be applied to an example in which a recommendation (S1114) is executed when a predetermined condition is satisfied.

The predetermined condition is, for example, at least one of the following:
the motion score reaches a predetermined threshold or more; and
the change amount of the motion score (for example, the difference from the previous motion score) reaches a predetermined threshold or more.

In the present embodiment, an example is shown in which the user position P(t), user velocity V(t), user pressure PR(t), user tempo T(t), and user acceleration A(t) are specified for each frame argument t, but the scope of the present embodiment is not limited to this.

This embodiment is also applicable to an example in which the user position, user velocity, user pressure, user tempo, and user acceleration are specified for each combination of a plurality of frames in a predetermined period (hereinafter referred to as a “frame group”).

For example, in the analyzing image (S1111), the processor 12 calculates, for each frame group, an average value of the user position, an average value of the user velocity, an average value of the user pressure, an average value of the user tempo, and an average value of the user acceleration.

As a result, even if a user motion at a certain moment deviates from the exemplary motion, if the user motion during a specified period does not deviate significantly from the exemplary motion, navigation information can be presented as if the user motion does not deviate from the exemplary motion.

As an example, when a user motion rotates a hand, even if the user motion deviates to the left or right within a certain distance from the exemplary motion, navigation information is presented as if the user motion has not deviated from the exemplary motion.

Therefore, even if the user improves the user motion after viewing the navigation information, it is possible to guide the user to appropriately improve the user motion.

In the present embodiment, an example has been shown in which the motion scores along the time series are displayed in the form of a graph on the screen P1111 (FIG. 8), but the scope of the present embodiment is not limited to this.

This embodiment is also applicable to an example in which the motion scores along a time series are displayed in the form of a trajectory heat map.

This makes it possible to present to the user in an easy-to-understand visual manner whether the motion of each part is good or bad in the evaluation of the position.

For example, when applying foundation evenly to the face, the user can easily know whether he/she has applied too much or has left some areas unapplied.

In the present embodiment, an example in which navigation information is presented while a beauty motion is performed has been described, but the scope of the present embodiment is not limited to this.

This embodiment is also applicable to an example in which navigation information is presented after a beauty motion is performed.

In this case, for example, when the user gives the client apparatus 10 a user instruction to have a beauty motion presented, the client apparatus 10 transmits the user instruction to the server 30.

In response to the user's instruction, the server 30 transmits navigation information corresponding to the beauty motion to the client apparatus 10.

The client apparatus 10 displays the navigation information on a display.

This allows the user to check the navigation information after completing the beauty motion.

In the present embodiment, an example has been shown in which a common exemplary model M is used in evaluating motion (S1112), but the scope of the present embodiment is not limited to this.

This embodiment can also be applied to an example in which the exemplary model M is changed for each user.

In the first example, the memory 11 stores an exemplary model M for each user attribute.

In evaluating motion (S1112), the processor 12 refers to the user database (FIG. 4) to identify user attributes (gender, as an example) associated with the user identification information, and selects an exemplary model M corresponding to the identified user attributes.

In the second example, the memory 11 stores an exemplary model M for each user preference.

In evaluating motion (S1112), the processor 12 refers to the user database (FIG. 4) to identify user preferences (for example, facial features) associated with the user identification information, and selects an exemplary model M corresponding to the identified user preferences.

In the third example, the memory 11 stores an exemplary model M for each user attribute, an exemplary model M for each user preference, and an exemplary model M for each skin concern.

In evaluating motion (S1112), the processor 12 refers to the user database (FIG. 4) to identify the skin concerns of the user associated with the user identification information, and selects an exemplary model M corresponding to the identified skin concerns.

Although the embodiments of the present invention are described in detail above, the scope of the present invention is not limited to the above embodiments.

Further, various modifications and changes can be made to the above embodiments without departing from the spirit of the present invention.

In addition, the above embodiments and variations may be combined.

### REFERENCE SIGNS LIST

1: Information processing system
10: Client apparatus
11: Memory
12: Processor
13: Input and output interface
14: Communication interface
15: Camera
20: Wearable sensor
30: Server
31: Memory
32: Processor
33: Input and output interface
34: Communication interface

1. An apparatus comprising a processor configured to:
acquire a user video including a beauty motion of a user's hand on each beauty target part;
identify a motion difference between an exemplary motion and the beauty motion by comparing the exemplary motion with the beauty motion, the motion difference including a position difference which is a motion difference related to a position of the beauty motion and a velocity difference which is a motion difference related to a velocity of the beauty motion; and
generate navigation information corresponding to the motion difference for each beauty target part.

2. The apparatus of claim 1, wherein the processor presents the navigation information to the user.

3. The apparatus of claim 2, wherein the processor generates a navigation image as the navigation information
and displays the navigation image superimposed on the user video.

4. The apparatus of claim 3, wherein the navigation image includes a position guidance image that guides a position of the beauty motion and a velocity guidance image that guides a velocity of the beauty motion, and
the processor displays the position guidance image superimposed on the user video, displays the velocity guidance image superimposed on the user video, and changes the velocity guidance image depending on the velocity of the beauty motion.

5. The apparatus of claim 3, wherein the processor generates an image of a hand that changes depending on a position of the beauty motion as the navigation image.

6. The apparatus of claim 1, wherein the processor converts predetermined sound information depending on the motion difference to generate a navigation sound as the navigation information.

7. The apparatus of claim 1, wherein the motion difference includes an acceleration difference related to an acceleration of the user's hand.

8. The apparatus of claim 1, wherein the motion difference includes a pressure difference related to a user pressure being a pressure applied to a face of the user.

9. The apparatus of claim 1, wherein the motion difference includes a tempo difference related to a tempo of the user's hand movement.

10. The apparatus of claim 1, wherein the processor displays an avatar image of the user superimposed on an image of the user's face; and
a changes a pixel of the avatar image at a position to which the beauty motion is applied.

11. The apparatus of claim 10, wherein the processor erases pixels of the avatar image at the position to which the beauty motion is applied to reveal the image of the user's face at the position to which the beauty motion is applied.

12. The apparatus of claim 10, wherein the processor applies makeup to the avatar image by changing a color of a pixel of the avatar image at the position to which the beauty motion is applied.

13. The apparatus of claim 1, wherein the processor calculates a score of the beauty motion; and
presents the navigation information and the score to the user while the beauty motion is performed.

14. The apparatus of claim 13, wherein the processor calculates the score based on a scenario in which the exemplary motion is described along a time series for each beauty target part and each type of beauty motion.

15. The apparatus of claim 1, wherein the processor analyzes a facial expression of the user,
and generates navigation information generates navigation information depending on a combination of the motion difference for each beauty target part and the analysis results of the facial expression.

16. An information processing method, comprising steps executed by a computer of:
acquiring a user video including a beauty motion of a user's hand on each beauty target part;
identifying a motion difference between an exemplary motion and the beauty motion by comparing the exemplary motion and the beauty motion, the motion difference including a position difference which is a motion difference related to a position of the beauty motion and a velocity difference which is a motion difference related to a velocity of the beauty motion; and
generating navigation information corresponding to the motion difference for each beauty target part.

17. A non-transitory computer-readable medium storing instructions to operate a computer as a module configured to:
acquire a user video including a beauty motion of a user's hand on each beauty target part;
identify a motion difference between an exemplary motion and the beauty motion by comparing the exemplary motion with the beauty motion, the motion difference including a position difference which is a motion difference related to a position of the beauty motion and a velocity difference which is a motion difference related to a velocity of the beauty motion; and
generate navigation information corresponding to the motion difference for each beauty target part.

18. The method of claim 16, further comprising a step of presenting the navigation information to the user.

19. The method of claim 18, further comprising a step of generating a navigation image as the navigation information and displays the navigation image superimposed on the user video.

20. The method of claim 17, wherein the instructions to operate the computer as a module configured to present the navigation information to the user.
